(19) United States
(12) Patent Application Publication
(10) Pub. No.: US 2017/0107975 A1
(43) Pub. Date: Apr. 20, 2017

(54) Vertical and Geographical Placements of Arrays of Vertical-Axis Wind-Turbines

(71) Applicant: Wind Harvest International, Inc., Point Reyes Station, CA (US)

(72) Inventors: Kevin J. Wolf, Davis, CA (US); Robert Nasson Thomas, Ventura, CA (US)

(73) Assignee: Wind Harvest International, Inc.

(21) Appl. No.: 15/296,926

(22) Filed: Oct. 18, 2016

Related U.S. Application Data
(60) Provisional application No. 62/243,373, filed on Oct. 19, 2015.

(51) Int. Cl. F03D 13/10; F03D 9/00; F03D 9/25

(52) U.S. Cl. CPC F03D 13/10; F03D 9/25; F03D 9/005; F05B 2220/706; F05B 2240/211; F05B 2240/221; F05B 2250/30

(57) ABSTRACT

Multiple vertical-axis wind-turbines are aligned in a geometric array relative to a horizontal-axis wind-turbine. The vertical-axis wind-turbines are placed in close proximity to the horizontal axis wind turbine. The turbines are in close enough proximity to each other to have an effect on wind conditions that create lift on a turbine blade and turn the rotor of the horizontal axis wind turbine. The wind conditions caused by the vertical axis wind turbines include any of i) a wind wall effect, ii) increased pressure difference between a front side and a back side of the rotor of the horizontal axis wind turbine, and iii) downwind vertical mixing of the air. The vertical-axis wind-turbines and horizontal axis wind turbine are configured to use the wind conditions to convert wind into increases in generated electrical power.

### RELATED APPLICATIONS

This application claims the benefit of and priority to the Provisional Application Ser. No. 62/243,373, titled “Vertical and Geographical Placements of Arrays of Vertical-Axis Wind-Turbines”, filed Oct. 19, 2015, which is herein incorporated by reference.

### FIELD

Example embodiments of processes, apparatuses, and systems for placing vertical-axis wind-turbines within wind farms and/or around horizontal-axis wind-turbines are discussed.

### BACKGROUND

A wind turbine may convert air current, i.e. wind, into electrical power. A wind turbine may capture wind based on the shape of a turbine blade. The wind creates lift on the turbine blade, causing the turbine blade to rotate around a shaft. The torque from the turbine blade on the shaft may cause the shaft to rotate, driving a magnetic rotor to rotate between a pair of coils, generating an electrical current. The power in the wind is the cube of the wind speed so any increase in wind speed may create a significant increase in the energy output of wind turbines. Horizontal-axis wind-turbines may have problems in turbulent winds and may have to be placed higher above the ground and far apart from each other and away from upwind obstacles in order to prevent damaging turbulence from reaching their drive trains.

### SUMMARY

Embodiments discussed below relate to placing vertical-axis wind-turbines in a land plot and a system with those placed vertical-axis wind-turbines.

In an embodiment, two or more vertical-axis wind-turbines are aligned in a geometric array relative to a horizontal-axis wind-turbine. The two or more vertical-axis wind-turbines are placed in close proximity in distance to the horizontal-axis wind-turbine. The vertical-axis wind-turbines and the horizontal-axis wind-turbine are in close enough proximity to each other to have an effect on wind conditions that create lift on a turbine blade and turn the rotor of the horizontal axis wind turbine. The wind conditions caused by the two or more vertical-axis wind-turbines include any of i) a wind wall effect (aka “porous wind fence effect”) to create multiple zones of wind conditions, above a height or on the sides of the vertical-axis wind-turbines, where increased wind speeds create additional lift on a turbine blade and turn the rotor of the horizontal axis wind turbine, ii) a pressure difference between a front side and a back side of the turbine blade of the horizontal-axis wind-turbine, iii) a coupled vortex effect with vertical mixing, and iv) any combination of these. The vertical-axis wind-turbines and horizontal-axis wind-turbine are configured to use the wind conditions to convert wind into increases in generated electrical power. A set of vertical-axis wind-turbines may affect wind conditions on one or more horizontal-axis wind-turbines on a plot of land.

This Summary is provided to introduce an example selection of concepts in a simplified form that is further described below in the Detailed Description. This Summary is not intended to identify key features or essential features of the claimed subject matter, nor is it intended to be used to limit the scope of the claimed subject matter.

### DRAWINGS

In order to describe the manner in which the above-recited and other advantages and features can be obtained, a more particular description is set forth and will be rendered by reference to specific embodiments thereof, which are illustrated, in the appended drawings. Understanding that these drawings depict only typical embodiments and are not therefore to be considered to be limiting of its scope, implementations will be described and explained with additional specificity and detail through the use of the accompanying drawings.

FIGS. 1A and 1B illustrate in a diagram an embodiment of a simple placement of an array of vertical-axis wind-turbines upwind of a horizontal-axis wind-turbine between zero and forty meters upwind.

FIGS. 2A and 2B illustrate in a diagram an embodiment of one example way in which vertical-axis wind-turbine heights may vary within a row to change how wind flowing through their rotor may create vertical mixing and increase the rotor area of the horizontal-axis wind-turbine that is positively affected by the wind wall effect.

FIGS. 3A, 3B, 4A, 4B, 5A, 5B, 6A, and 6B illustrate diagrams of four examples of many ways in which an array of vertical-axis wind-turbines may be placed in distance closely downwind and higher above ground than the shorter array of vertical-axis wind-turbines installed upwind so that the upwind array increases the wind speed realized by the taller array; and thus, collectively the two sets of arrays increase wind speeds or decrease turbulence realized by the downwind horizontal-axis wind-turbines.

FIGS. 7A, 7B, 8A, 8B, 9A and 9B illustrate diagrams of three examples of many ways in which arrays of vertical-axis wind-turbines may be placed immediately adjacent to a horizontal-axis wind-turbine tower to minimize turbulence the horizontal-axis wind-turbine would otherwise realize or increase wind speeds through its rotors, and create a speed up effect between the vertical-axis-wind-turbine blades and the horizontal-axis wind-turbine tower that benefits the energy output of the adjacent vertical-axis wind-turbines while making the best use of the space available.

Note, the wind also speeds up around the edge of a vertical-axis wind-turbine array. The vertical-axis wind-turbines as individuals or pairs can arc up in an array to better match the arc of the horizontal-axis wind-turbine blades. The wind speeds up over the top and on the side of the vertical-axis wind-turbines to increase the wind speeds realizing the horizontal-axis wind-turbine blades.

FIGS. 10A, 10B, 11A, and 11B illustrate diagrams of two example ways in which arrays of vertical-axis wind-turbines may be placed in a U or V or W type formations upwind, downwind or directly beneath the horizontal-axis wind-turbines.

FIGS. 12 to 15 illustrate some examples in which coupled pairs of vertical-axis wind-turbines can increase the wind speeds realized by the downwind horizontal-axis wind-turbines and maximize the number of vertical-axis wind-turbines placed on the land.

FIGS. 16A to 21 illustrate some examples of how vertical-axis wind-turbines can be placed directly downwind or under and close to a horizontal-axis wind-turbine to increase the wind speeds that the horizontal-axis wind-turbine rotor realizes while making best use of the available space and the energy available from winds entering the horizontal-axis wind-turbine from different wind directions.

FIGS. 22A and 22B illustrate a diagram of an embodiment of how vertical-axis wind-turbines on taller towers can be placed in the gaps between and very close to and even overlapping the vertical-axis wind-turbines on shorter towers where the taller tower could force the confinement of the wind speed behind the upwind vertical-axis wind-turbines and increase the speed of the wind realized by the shorter vertical-axis wind-turbines.

FIG. 23 illustrates, in a block diagram, an embodiment of a computing device to assist in the placement of one or more rows of vertical-axis wind-turbines in a plot of land.

### DETAILED DESCRIPTION

Embodiments are discussed in detail below. In the following description, numerous specific details are set forth, such as examples of specific number of turbines, components, types of placement details, etc. in order to provide a thorough understanding of the present disclosure. It will be apparent, however, to one skilled in the art that the present disclosure may be practiced without these specific details. In other instances, well known components or methods have not been described in detail but rather in a block diagram in order to avoid unnecessarily obscuring the present disclosure. Also, a first turbine does not mean that the first turbine is sequentially before a second turbine. Rather, a first turbine simply conveys that the first turbine is a different turbine than the second turbine. Thus, the specific details set forth are merely exemplary. The specific details may be varied from and still be contemplated to be within the spirit and scope of the present disclosure. While specific implementations are discussed, it should be understood that this is done for illustration purposes only. A person skilled in the relevant art will recognize that other components and configurations may be used without parting from the spirit and scope of the subject matter of this disclosure.

In general, a set of vertical-axis wind-turbines are discussed. In an embodiment, a method is discussed to place the vertical-axis wind-turbines within a wind farm. Two or more vertical-axis wind-turbines aligned in a geometric array are placed relative to a horizontal-axis wind-turbine. The two or more vertical-axis wind-turbines are placed in close proximity to the horizontal-axis wind-turbine. Both the vertical-axis wind-turbines and the horizontal-axis wind-turbine are also set in close enough proximity to each other to have an effect on wind conditions that create lift on a turbine blade and turn the rotor of the horizontal axis wind turbine. Each horizontal-axis wind-turbine in the wind farm may have a set of vertical-axis wind-turbines that effect wind conditions on that horizontal-axis wind-turbine. The wind conditions caused by the two or more vertical-axis wind-turbines include any of i) a wind wall effect (aka “porous wind fence effect”) to create multiple zones of wind conditions, above a height of the vertical-axis wind-turbines, that cause the effect on the wind conditions that create lift on a turbine blade and turn the rotor of the horizontal axis wind turbine, ii) a pressure difference between a front side and a back side of the turbine blade of the horizontal-axis wind-turbine, iii) a coupled vortex effect with downwind vertical mixing of the air that brings faster moving wind closer to the ground, and iv) any combination of these. The vertical-axis wind-turbines and horizontal-axis wind-turbine are configured to use the wind conditions to convert wind into increases in generated electrical power.

Some example implementations may also include a machine-implemented method on a tangible machine-readable medium having a set of instructions detailing the method. The data and instructions are stored thereon for at least one processor, a wind turbine placement module, and/or an automatic wind turbine placement device.

Different configurations of the vertical-axis wind-turbines around individual or rows of horizontal-axis wind-turbines can create the many benefits as discussed herein.

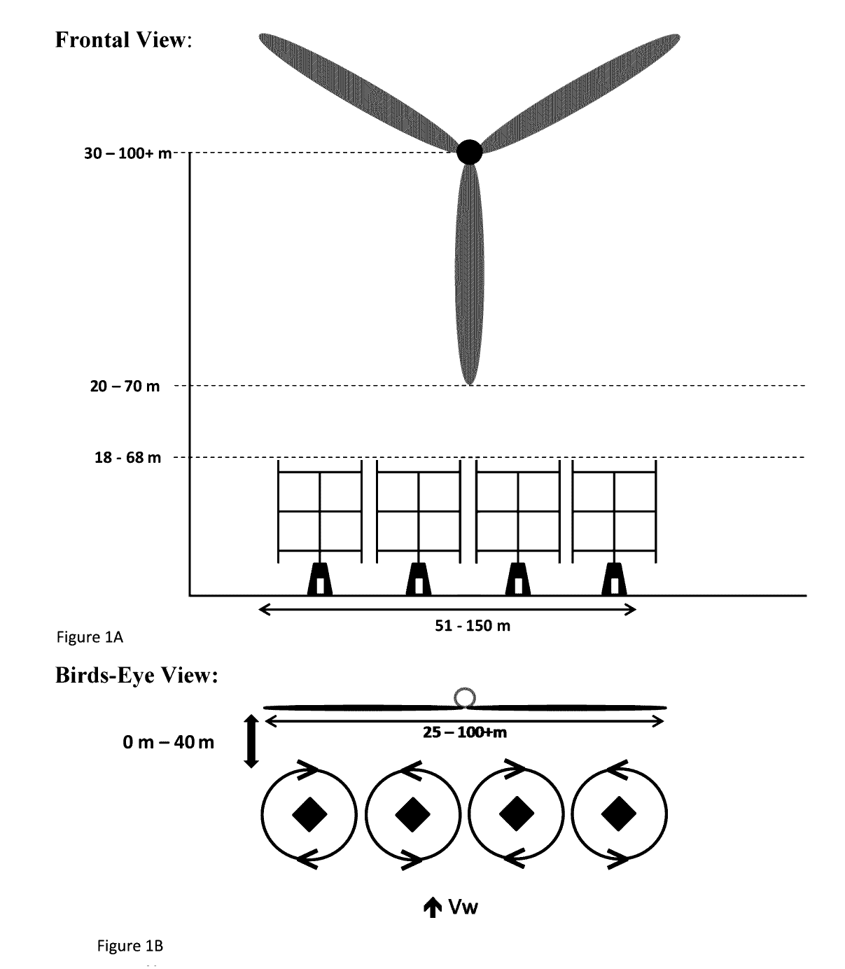

FIG. 1A illustrates a frontal view diagram of an embodiment of a horizontal-axis wind-turbine aligned with a row of vertical-axis wind-turbines placed in front, from the direction of the wind, of the horizontal-axis wind-turbine. The placement of the array of vertical-axis wind-turbines upwind of a horizontal-axis wind-turbine may be placed in distance between zero and forty meters upwind. The four vertical-axis wind-turbines are each paired with another vertical-axis wind-turbine. The four vertical-axis wind-turbines are aligned in a row. In this alignment, each vertical-axis wind-turbine has its rotor turning counter rotational relative to the vertical-axis wind-turbine neighboring that vertical-axis wind-turbine.

The two or more vertical-axis wind-turbines may be aligned in a geometric array relative to a horizontal-axis wind-turbine. The two or more vertical-axis wind-turbines are placed in distance in close proximity to the horizontal-axis wind-turbine. The vertical-axis wind-turbines and the horizontal-axis wind-turbine are in close enough proximity to each other to have an effect on wind conditions that create lift on a turbine blade and turn the rotor of the horizontal axis wind turbine. The wind conditions caused by the two or more vertical-axis wind-turbines include any of i) a wind wall effect to create multiple zones of wind conditions, above a height of the vertical-axis wind-turbines, that cause the effect on the wind conditions that create lift on a turbine blade and turn the rotor of the horizontal axis wind turbine, ii) a pressure difference between a front side and a back side of the turbine blade of the horizontal-axis wind-turbine, iii) a coupled vortex effect with downwind vertical mixing of the air that brings faster moving wind closer to the ground, and iv) any combination of these. The vertical-axis wind-turbines and horizontal-axis wind-turbine are configured to use the wind conditions to convert wind into increases in generated electrical power. A set of vertical-axis wind-turbines may affect wind conditions on one or more horizontal-axis wind-turbines on a plot of land.

In this example, arrays of two, three, four and more vertical-axis wind-turbines of varying heights and diameters relative to horizontal-axis wind-turbines may create “wind walls” that force wind to speed up over the top of the vertical-axis wind-turbines and increase the speed of the wind that enters downwind horizontal-axis wind-turbine rotors. The array of vertical-axis wind-turbines increase wind speeds into and provide other benefits to a horizontal-axis wind-turbine rotor spinning directly above or up to four vertical-axis wind-turbine rotor diameters in distance upwind or downwind of the horizontal-axis wind-turbine rotor.

The row of vertical-axis wind-turbines forms the wind wall. Above the height of the vertical-axis wind-turbines, the wind wall have will have two zones. A first zone of wind caused at the tops of the vertical-axis wind-turbines forming a wind wall is a turbulence zone in which the blade of the horizontal-axis wind-turbine can be adversely affected due to the turbulent wind when the blade of the horizontal-axis wind-turbine enters into this turbulence zone. The speed of the wind may be increased in the turbulence zone but also a lot of turbulence exists. The second zone of affected wind due to the wind wall is above the turbulence zone and is a speed zone in which the wind speed is increased but the turbulence is not substantially increased. The wind speed in this zone is increased due to the acceleration created over the top of the array by the wind wall effect. In the second zone, the wind speed is increased. Thus, when the blade of the horizontal-axis wind-turbine extends and enters into this speed zone, then the force causing lift on the blade is affected by the increased wind speed in this second zone. The wind primarily driving the rotating of the blades of the horizontal-axis wind-turbine is coming in a general uniform straight ahead direction at the horizontal-axis wind-turbine in this location.

The array of vertical-axis wind-turbines could extend out to the full diameter of the horizontal-axis wind-turbine rotor and beyond. The array is placed directly under or slightly upwind of the horizontal-axis wind-turbine rotor to induce the “porous wind fence” effect where the wind speeds up over the top of the array. In this embodiment, the bottom tip of the horizontal-axis wind-turbine blade passes at 2 m above the vertical-axis wind-turbine array to avoid an assumed 2m turbulence zone above the array. The height of this turbulence zone may vary based on vertical-axis wind-turbine solidity, rotor diameter, blade tip design, topography, wind conditions, co or counter rotation, and other factors. In general, the horizontal-axis wind-turbine blade tip should not enter this zone of turbulence.

FIG. 1B shows the bird's eye view where the row of vertical-axis wind-turbines is located zero meters to forty meters in front of the centerline of the tower that mounts the wind turbine blades and rotor are mounted on. Different configurations of vertical-axis wind-turbine arrays upwind of or directly underneath horizontal-axis wind-turbines can reduce or eliminate the problematic turbulence that might otherwise be caused by other configurations of vertical-axis wind-turbine arrays. The vertical-axis wind-turbines are located ahead of or directly underneath the tower supporting the rotor of the horizontal-axis wind-turbine to create the wind wall in which above the wind wall two zones of wind are created.

The first zone is a turbulence zone. The second zone is an increased wind speed zone. When the blade of the horizontal-axis wind-turbine is driven by the wind in the second zone with the increased wind speed, then that causes more lift on the horizontal-axis wind-turbine blades; and thus, more electrical power generated from the turbine.

The row of vertical axis wind-turbines being located zero meters (i.e. directly underneath the horizontal-axis wind-turbine) or up to 40 meters away are close enough in proximity to the horizontal-axis wind-turbine such that the wind wall effect creates more driving force on the blade of the horizontal-axis wind-turbine. However, in an embodiment, the closer that the row of vertical-axis wind-turbines is to the bottom tip of the horizontal-axis wind-turbine blades, the more effect the wind wall and its wind zones will have on the horizontal-axis wind-turbine.

In this example, the horizontal-axis wind-turbine is aligned with this row of four vertical-axis wind-turbines such that the row of vertical-axis wind-turbines are placed any of i) centerline with and ii) upwind of the horizontal-axis wind-turbine. The set of vertical-axis wind-turbines in the row are each paired with a neighboring vertical-axis wind-turbine and may co-rotate or counter rotate with that neighboring rotor. The vertical-axis wind-turbines create the wind walls that force wind to speed up over the top of the vertical-axis wind-turbines and increase the speed of the wind that affects the downwind blades of the horizontal-axis wind-turbine. The wind wall creates the two zones. In the turbulence zone, the blade of the horizontal-axis wind-turbine can be adversely affected due to the turbulent wind when the blade of the horizontal-axis wind-turbine enters into this turbulence zone. The second zone of affected wind due to the wind wall is above the turbulence zone and is a speed zone. In the speed zone, the wind speed is increased for wind directly overhead or downwind of the wind wall but the turbulence is not substantially increased. In the speed zone, where the wind speed is increased, when any of the blades of the horizontal-axis wind-turbine extend and enter into this speed zone, then a force causing lift on these blades is effected by the increased wind speed in this second zone.

The vertical-axis wind-turbine arrays in close proximity of the horizontal-axis wind-turbines may allow wind farm owners to make double use of existing roads, grading, infrastructure, valuable ridgeline land, and more.

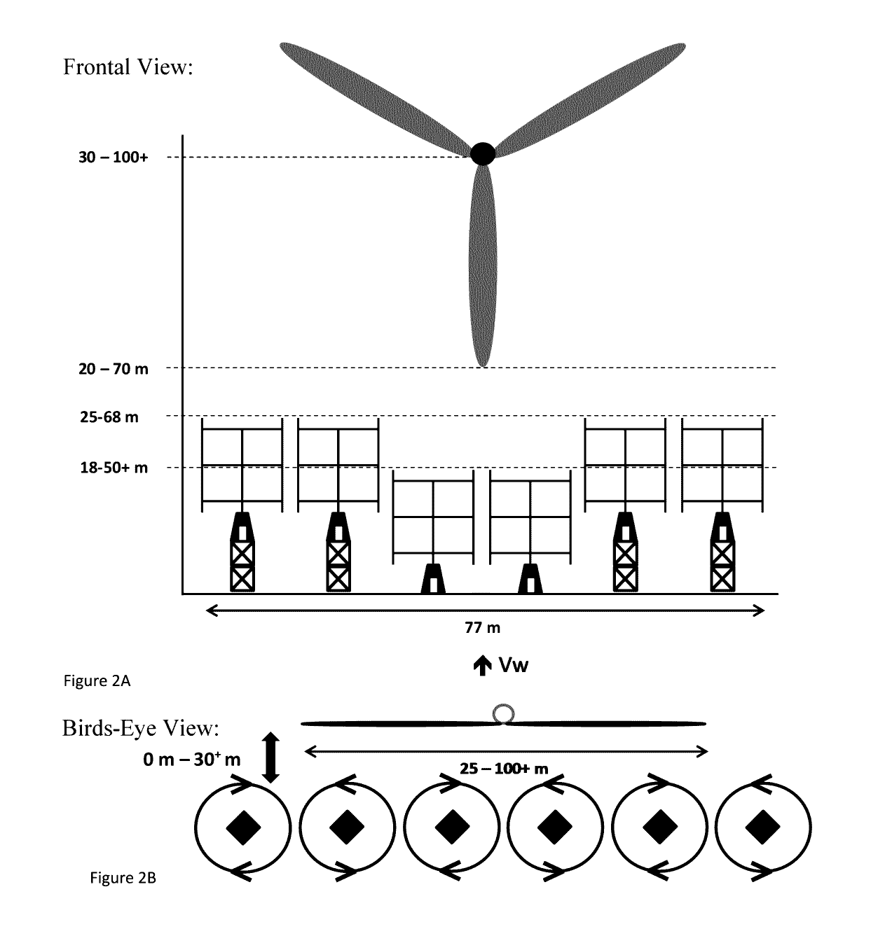

FIGS. 2A and 2B illustrate in a diagram an embodiment of one example way in which vertical-axis wind-turbine heights may vary within a row to change how wind flowing through their rotor may create vertical mixing and change turbulence to the benefit of downwind horizontal-axis wind-turbines. FIG. 2A illustrates a frontal view. FIG. 2B illustrates a bird's eye view. The array of vertical-axis wind-turbines are aligned in a row at different heights within a row. The heights of the pairs of vertical-axis wind-turbines and corresponding formed wind walls differ. Heights and other attributes of the vertical-axis wind-turbines may vary to bring the top of the vertical-axis wind-turbine blades directly underneath horizontal-axis wind-turbine blades and/or close to the bottom arc of the blade tip of the downwind horizontal-axis wind-turbine. In this example, the three sets of vertical-axis wind-turbines create roughly three channels of increased wind speed due to the wind wall effect. Each channel sets the corresponding wind wall effect to benefit the blades of the horizontal-axis wind-turbine as they rotate in their 360-degree circular path across the width of the row of vertical-axis wind-turbines. The vertical axis wind turbines at the edge of the row may be taller than the vertical axis wind turbines in the center of the row to increase the arc of the blade of the horizontal axis wind turbine that realizes an increase in wind speed.

The three formed channels boost wind speed and increase the lift on the turbine blade as it goes through its circular circumference motion. Starting off in the center channel, formed by the lowest height pair of vertical-axis wind-turbines, the length of the blade of the horizontal-axis wind-turbine enters into the increased wind speed zone created by the wind wall affect. In the first channel to the left of the centerline of the horizontal-axis wind-turbine another wind wall is formed with the taller pair of vertical-axis wind-turbines. As a blade of the horizontal-axis wind-turbine rises in its circular motion, then the height of the corresponding set of vertical-axis wind-turbines raise up in height to create a second wind wall affect. As the turbine blade continues in its circular circumference motion, then the blade is exposed to this second wind wall's affect and increases the torque pushing the blade. The blades of the horizontal-axis wind-turbine enter the increased wind speed zone while not entering the turbulence zone caused by the wind wall. Similarly, a third channel of wind wall affect is formed to the right of the horizontal-axis wind-turbine due to the height of the set of vertical-axis wind-turbine on the right side. In the third channel, the turbine blades of the horizontal-axis wind-turbine during their downward swing will enter into the increased wind speed zone while not entering the turbulence zone caused by the wind wall of the third channel. The turbine blade of the horizontal-axis wind-turbine in the increased wind speed zone is exposed to higher wind speeds and that is more torque and driving force on the blade. In an embodiment, each outside vertical-axis wind-turbine in the array can be placed from 10 to 90% higher than the neighboring inside vertical-axis wind-turbine to increase the arc of the horizontal-axis wind-turbine that benefits from the increase in wind speed going over that single taller vertical-axis wind-turbine.

In an embodiment, the shorter vertical-axis wind-turbines may be placed between taller vertical-axis wind-turbines in order to pass wind flow in the different channels to reduce downwind turbulence or increase the wind speeds that are realized by the downwind or overhead rotor of the horizontal-axis wind-turbines.

The vertical-axis wind-turbine heights may vary within a row to change how wind flowing over their rotors creates a higher wind speed reaching the horizontal-axis wind-turbine blades away from the lowest point of their arc. There may be 1, 2, 3 or more shorter vertical-axis wind-turbines of the same or differing heights below the bottom sweep of the horizontal-axis wind-turbine blade with 1, 2, 3 or more taller vertical-axis wind-turbines on either side to create the porous wind fence effect on the horizontal-axis wind-turbine blade as they sweep down and into or away and up from the vertical-axis wind-turbines in the middle. There may be another one or more of vertical-axis wind-turbines set on even taller towers to extend this speed up effect through a greater swept area of the horizontal-axis wind-turbine. This same configuration of vertical-axis wind-turbines of varying heights in an array may realize an increase in vertical mixing and planform kinetic flux and thus benefit a downwind horizontal-axis wind-turbine that is further downwind.

As discussed, the vertical-axis wind-turbines aligned in a row have two or more sets of vertical-axis wind-turbines set at the same or different heights within that row. A first set of vertical-axis wind-turbines is higher from the ground than a second set of vertical-axis wind-turbines in that row. Each different set of vertical-axis wind-turbines at the different heights forms its own wind wall and corresponding multiple zones of wind to affect the turbine blades and rotor of the horizontal-axis wind-turbine.

The shorter set of vertical-axis wind-turbines in that row is closer to a centerline of a tower supporting the horizontal-axis wind-turbine. The taller one or set of vertical-axis wind-turbines is farther from the centerline of the tower supporting the horizontal-axis wind-turbine. The multiple zones include a turbulence zone and a speed zone. The different heights of the wind walls formed benefit the lift on the blades of the horizontal-axis wind-turbine as they rotate circularly across the width of the row of vertical-axis wind-turbines. The speed zone of wind boosts wind speed and increases the lift on and torque realized by the turbine blades as they go through their circular circumference motion on the horizontal-axis wind-turbine.

Note that the number of vertical-axis wind-turbines in the center that are lower/shorter than the edge vertical-axis wind-turbines can vary from one turbine to many pairs of turbines. Also, the height of the vertical-axis wind-turbines can be within a few meters from the lower arc of the blades of the horizontal-axis wind-turbine. The height of the horizontal-axis wind-turbines are set for the blades to enter the speed zone of wind boosts but not the turbulence zone.

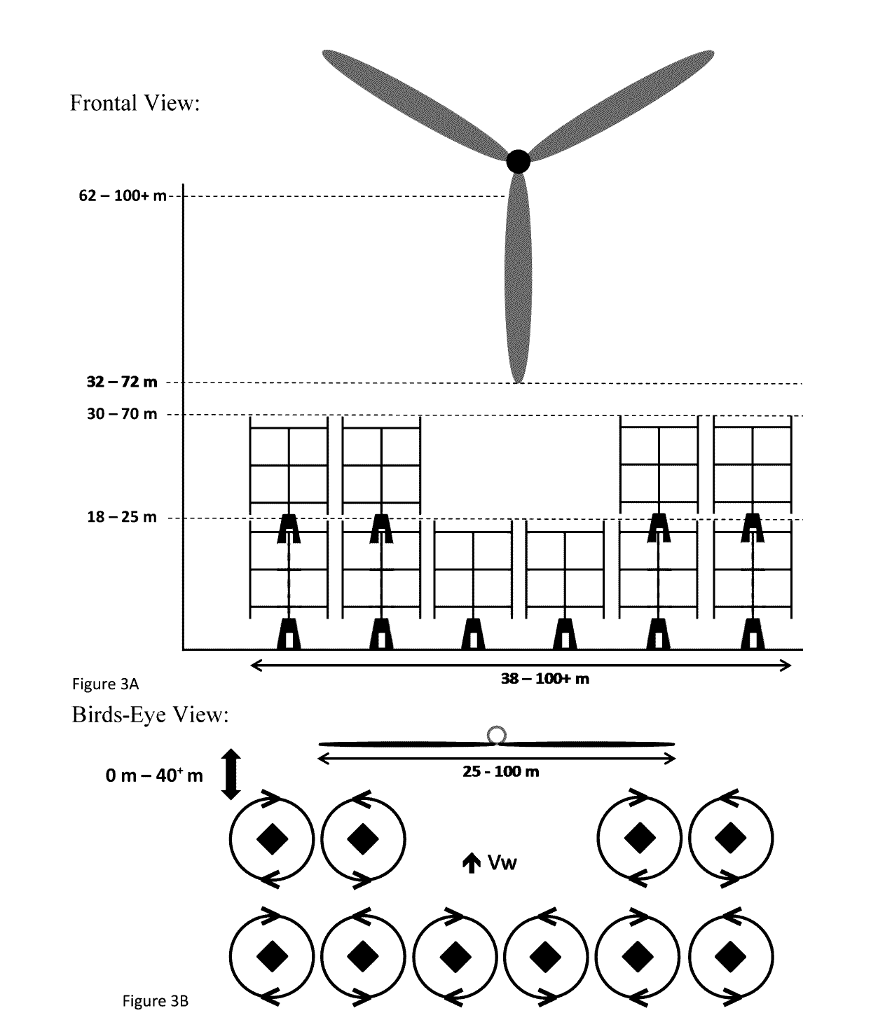

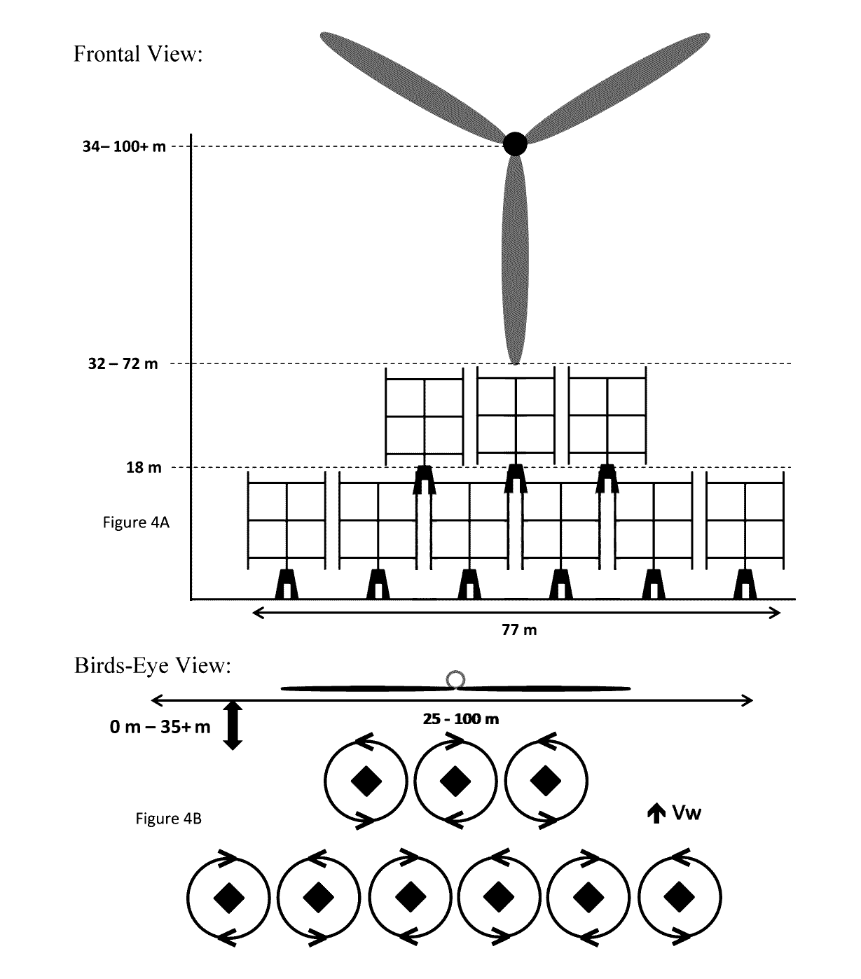

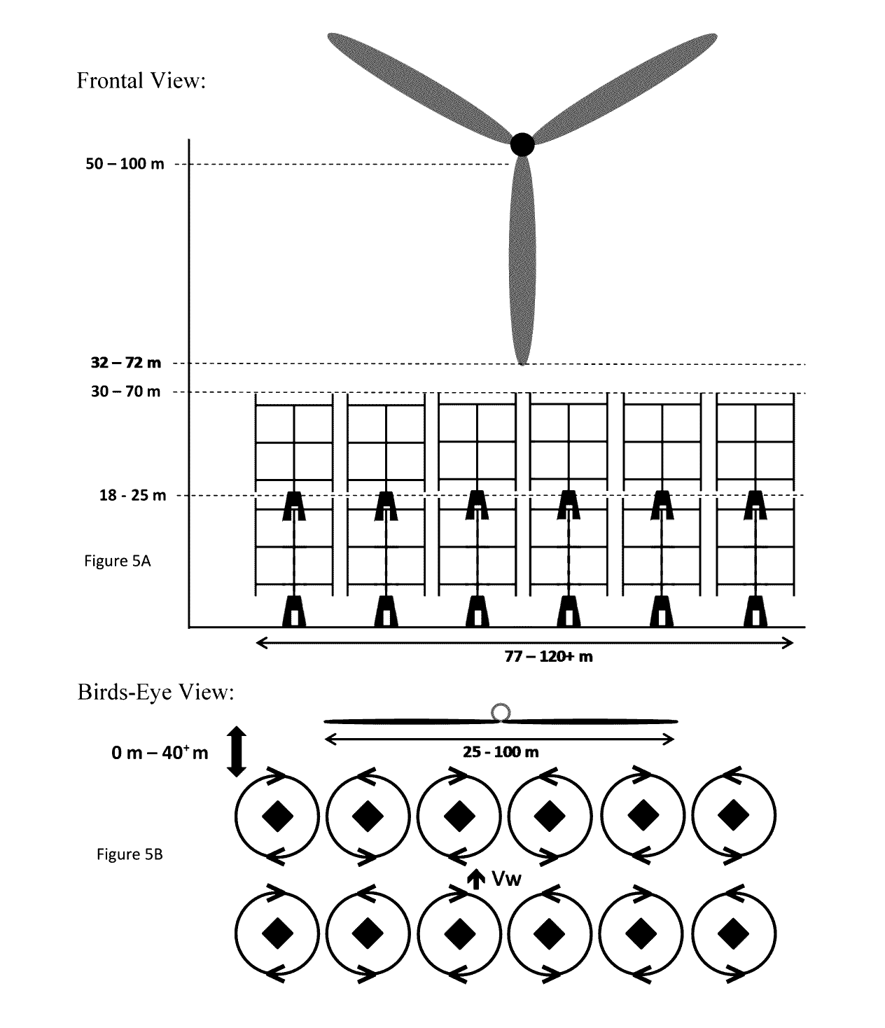

FIGS. 3A, 3B, 4A, 4B, 5A, 5B, 6A, and 6B illustrate diagrams of four examples of many ways in which an array of vertical-axis wind-turbines may be placed in distance directly under or somewhat upwind of a horizontal-axis wind-turbine rotor such that the array of shorter vertical-axis wind-turbines are installed upwind of the vertical-axis wind-turbines on taller towers creating a wind speed up effect over the top of the shorter vertical-axis wind-turbines into the taller vertical-axis wind-turbines behind. These two rows of vertical-axis wind-turbines may further increase the porous wind fence speed up effect realized by horizontal-axis wind-turbine's blades over or slightly behind the taller vertical-axis wind-turbines. The array of vertical-axis wind-turbines may extend beyond the rotor diameter of the horizontal-axis wind-turbine or it may not. Gaps in between the vertical-axis wind-turbines in the array may vary to either increase the wind speeds entering the horizontal-axis wind-turbine rotor or decrease the turbulence that the horizontal-axis wind-turbine blades might realize. Note, the specific lengths of vertical-axis wind-turbine arrays indicated on the drawings can vary as can the length of the horizontal-axis wind-turbine rotor diameter. Also, variations of the heights of the turbines, whether co-rotate or counter rotate and distances between pairs of vertical-axis wind-turbines may differ based on a site's wind directions and topographies.

FIG. 3A illustrates a frontal view. FIG. 3B illustrates a bird's eye view.

The array of vertical-axis wind-turbines may be aligned in two or more rows, where the rows are set at different heights. Multiple rows of the vertical-axis wind-turbines may be placed ahead of/prior to the location of the tower supporting the rotor and blade of the horizontal-axis wind-turbine. In this example, two sets of rows of vertical-axis wind-turbines are aligned with a horizontal-axis wind-turbine. The row of vertical-axis wind-turbines closer to the horizontal-axis wind-turbine is the tallest row. The row of vertical-axis wind-turbines farthest from the horizontal-axis wind-turbine is the shortest row. The taller row of vertical-axis wind-turbines is placed behind the first row of vertical-axis wind-turbine in order to benefit from the increased wind speed that flows past and over the top of the shorter row the vertical-axis wind-turbines. Thus, the wind wall effect created by the second row of vertical-axis wind-turbines creates a greater combined increase of the velocity of the wind than produced by merely one row of vertical-axis wind-turbines by itself. The two rows of vertical-axis wind-turbines must be proximately close enough to each other, within three turbine blade diameters of each other, in order to affect and combine the increase in wind speed in the speed zone from the wind wall produced by the tallest set of vertical-axis wind-turbines. The two rows of vertical-axis wind-turbines being in close proximity to each other combines the effects of the wind increase as long as the row closer to the horizontal-axis wind-turbine is taller than the row further away from the horizontal-axis wind-turbine.

Thus, the vertical-axis wind-turbines are also aligned in two or more rows at different heights. The vertical-axis wind-turbines are placed upwind to a location of a tower supporting the rotor and blades of the horizontal-axis wind-turbine. A first row of vertical-axis wind-turbines closer to the horizontal-axis wind-turbine is set as a highest row of vertical-axis wind-turbine from the ground. A second row of vertical-axis wind-turbines farthest from the horizontal-axis wind-turbine is set as a shortest row. The highest row of vertical-axis wind-turbines is placed downwind of the shortest row of vertical-axis wind-turbine and benefits from the increased wind speed that flows past and over the top of the shortest row the vertical-axis wind-turbines; and thus, the wind wall effect created by the second row of vertical-axis wind-turbines creates a greater combined increase of a velocity of the wind than produced by merely the shortest row of vertical-axis wind-turbines by itself.

The row of vertical-axis wind-turbines that are taller than a shorter row and placed in distance close behind creates an even greater speed up effect in order to benefit energy production of the downwind horizontal-axis wind-turbine.

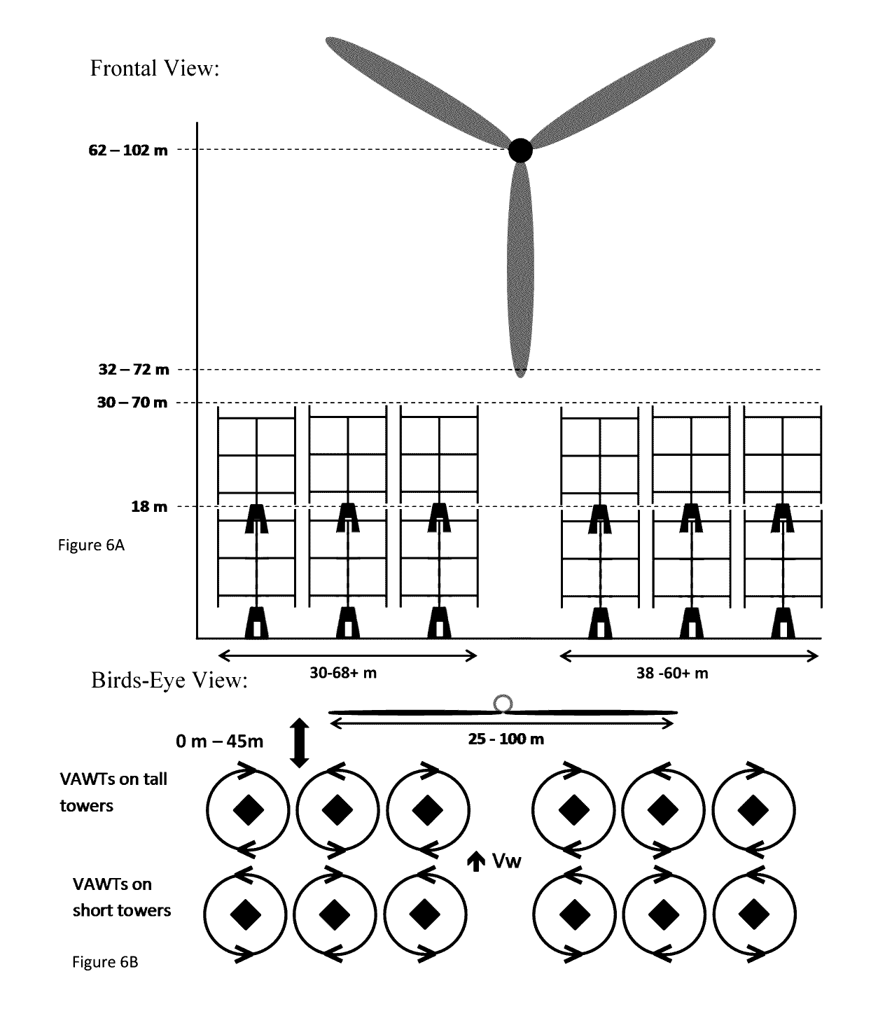

FIGS. 6A and 6B further illustrate that the aligned rows of vertical-axis wind-turbines have a gap between the two sets of vertical-axis wind-turbines. The gap may be placed in the arrays of vertical-axis wind-turbines.

The arrays of vertical-axis wind-turbines may have a series of co-rotated or counter-rotated rotors to negate any problematic turbulence. The vertical-axis wind-turbines can vary in how they counter and co-rotate to each other in the row or array. The distances between rows of turbines and sizes of their rotors or designs of their blade tips may vary to negate any problematic turbulence that the vertical-axis wind-turbines may create for downwind horizontal-axis wind-turbines. In an embodiment, the arrays of interspersed vertical-axis wind-turbines are separated from another array by up to one rotor diameter. Different configurations of vertical-axis wind-turbine arrays may increase the energy output of the nearby horizontal-axis wind-turbines.

In an embodiment, pairs of counter rotating vertical-axis wind-turbines may be spaced further apart from each other than they are in the pair and may be strategically placed upwind of each other in order to reduce downwind turbulence or increase the wind speeds that are realized by downwind horizontal-axis wind-turbines and/or vertical-axis wind-turbines.

In an embodiment, co-rotating vertical-axis wind-turbines may be placed within arrays of counter-rotating vertical-axis wind-turbines to reduce downwind turbulence or increase the wind speeds that are realized by downwind horizontal-axis wind-turbines and vertical-axis wind-turbines. The example vertical-axis wind-turbine shown illustrate with arrows the direction of rotation of their rotor.

In an embodiment, counter-rotating and co-rotating vertical-axis wind-turbines in closely placed configurations (less than one half of a rotor diameter between blades of pairs of adjacent vertical-axis wind-turbines) and of differing heights are separated by a varying distances within a row so that the downwind turbulence is minimized and downwind rows of vertical-axis wind-turbines can be placed closer to upwind rows without realizing loss of energy production by the downwind vertical-axis wind-turbines.

The vertical-axis wind-turbines are paired with a neighboring vertical-axis wind-turbine within the rows of vertical-axis wind-turbines. Each pair of vertical-axis wind-turbines has blades that are counter-rotating with respect to a neighboring vertical-axis wind-turbine within that row or are co-rotating with respect to a neighboring vertical-axis wind-turbine within another row. The counter-rotating blades and co-rotating blades of the neighboring vertical-axis wind-turbines are set in closely placed configurations. The neighboring blades pass by each other at a distance equal to or less than the radius of one of their rotors and at differing heights in a row so that downwind vertical mixing of the wind is increased and rows of vertical-axis wind-turbines downwind can be placed closer to upwind rows of vertical-axis wind-turbines without realizing loss of energy production by the downwind vertical-axis wind-turbines. Any turbulence that could reach the rotors of horizontal-axis wind-turbines is reduced and the wind speed entering the rotors of the horizontal-axis wind-turbines is increased.

In an embodiment, these combinations of vertical-axis wind-turbines may create downwind vertical mixing of the wind after it passes through, over and around them. The resulting increase in vertical mixing may bring faster moving wind from higher above the ground to a lower level. This may in turn increase the wind speeds realized by downwind horizontal-axis wind-turbine rotors.

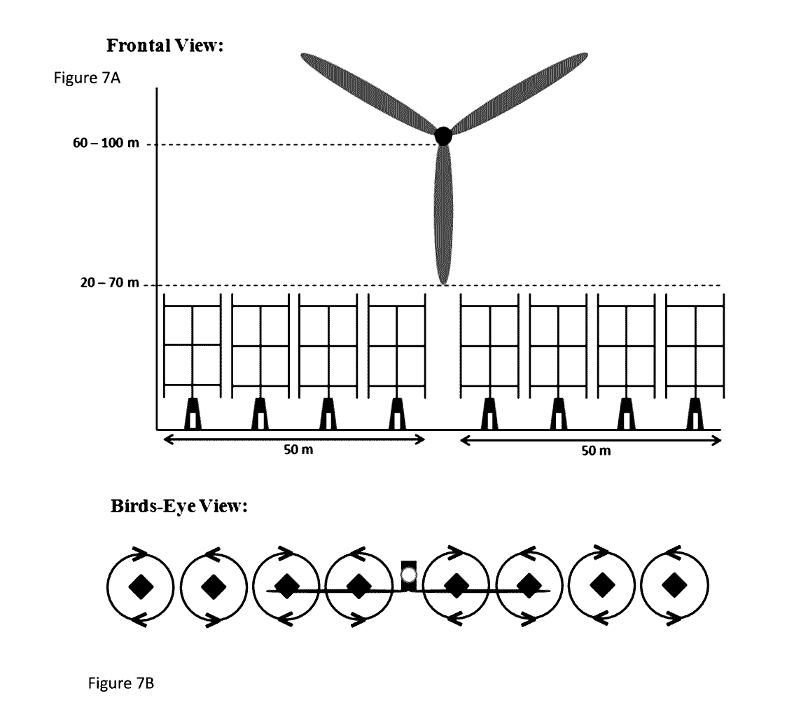

FIGS. 7A, 7B, 8A, 8B, 9A, and 9B illustrate diagrams of three examples of many ways in which arrays of vertical-axis wind-turbines may be placed immediately adjacent to a horizontal-axis wind-turbine tower to minimize turbulence the horizontal-axis wind-turbine will realize, and increase the wind speeds through the horizontal-axis wind-turbine rotors. In these figures, the horizontal-axis wind-turbine tower creates a narrow gap between it and its neighboring vertical-axis wind-turbines such that the wind speeds up between tower and the vertical-axis wind-turbine. The vertical-axis wind-turbine arrays may change in their orientation to account for variations in the wind directions that enter the horizontal-axis wind-turbine rotor.

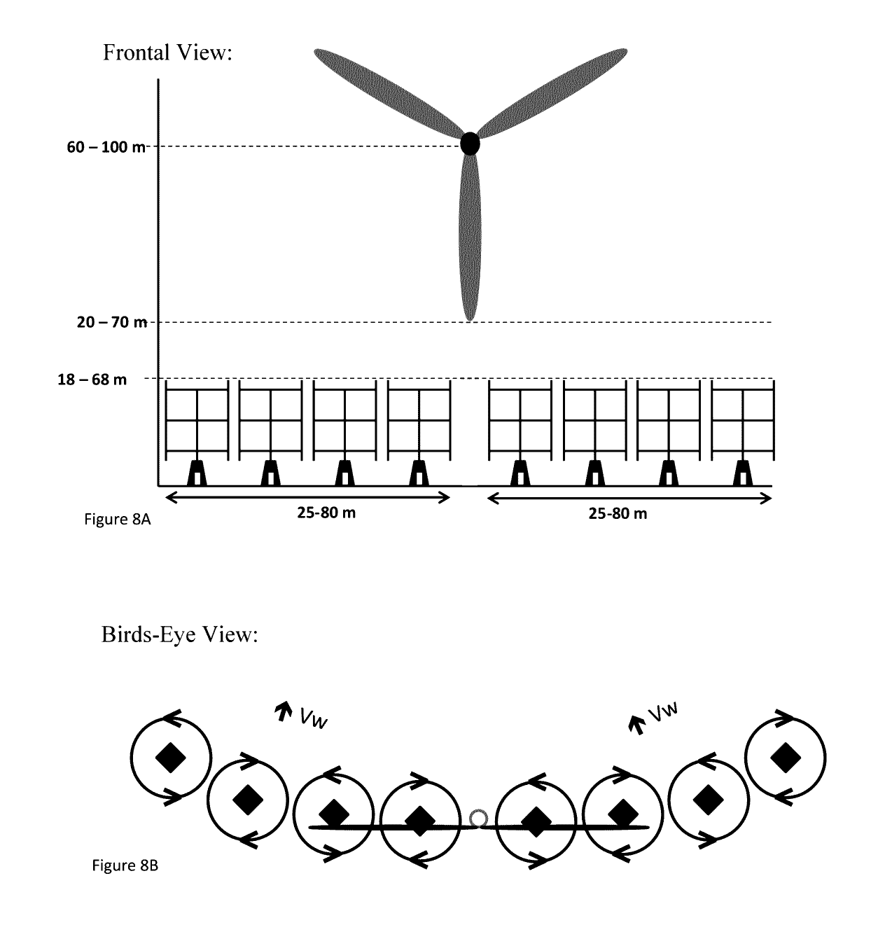

FIGS. 8A and 8B show a curved row of aligned vertical access wind turbines that create the wind wall affect because the free blowing wind direction is coming at two different angles at the horizontal axis wind turbine. Thus, instead of the wind coming in a generally uniform straight ahead direction at the horizontal axis wind turbine in this location, the wind primarily driving the blades may come from two different angles of direction at the horizontal-axis wind-turbine. The curved rows of vertical-axis wind-turbines correspond to the angle that the winds are coming at the horizontal-axis wind-turbine. The curved row of aligned vertical access wind turbines are shaped to maximize benefits of the wind coming from different directions and increase the wind speeds that are realized by the downwind or overhead rotor of the horizontal axis wind turbine.

Different row configurations of tightly spaced pairs of vertical-axis wind-turbines with pairs being separated by varying differences in a row and between rows may have positive benefits for downwind horizontal-axis wind-turbines when placed on a slope or on or among hills and ridgelines that upwind of the horizontal-axis wind-turbines. These vertical-axis wind-turbine rotors could extend above the height of the bottom of the horizontal-axis wind-turbine blade tip and create an increase in wind speed to the horizontal-axis wind-turbines.

Thus, different configurations of vertical-axis wind-turbine arrays around a horizontal-axis wind-turbine can maximize energy production for vertical-axis wind-turbines and horizontal-axis wind-turbines in wind sites that do not have uni-directional wind resources (i.e. where the wind comes from many different directions over the course of a year). In this example, the vertical-axis wind-turbine rotors in the row curve downwind to better accommodate wind coming in from different angles than from 0 degrees. Different array configurations of vertical-axis wind-turbines can also maximize the use of ridgeline land and other locations where the space available to install vertical-axis wind-turbines and horizontal-axis wind-turbines is limited.

Variations may be made in how the vertical-axis wind-turbine arrays may curve or bend or connect.

The horizontal-axis wind-turbine tower can be close enough to the vertical-axis wind-turbine blades to cause the wind to speed up the gap and assist in the coupled vortex effect.

Note as previously discussed, the set of vertical-axis wind-turbines may include two or more vertical-axis wind-turbines, such as each set having four vertical-axis wind-turbines in this example. The rows of vertical access wind turbines may be coupled pairs where each vertical-axis wind-turbine is coupled in close proximity to a neighboring vertical-axis wind-turbine.

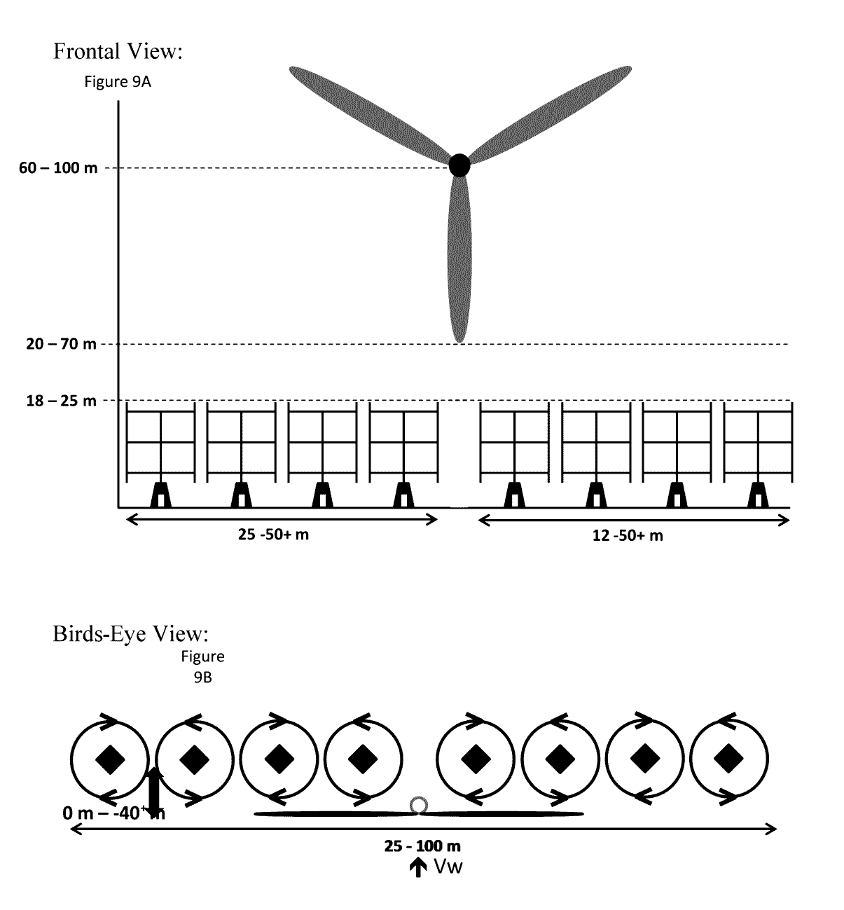

FIGS. 9A and 9B illustrate diagrams of two sets of arrays of vertical-axis wind-turbines placed immediately adjacent to a horizontal-axis wind-turbine tower to minimize turbulence on the horizontal-axis wind-turbine. A gap exists between the two sets of arrays of vertical-axis wind-turbines. The row of vertical-axis wind-turbines can be located slightly behind the horizontal-axis wind-turbine rotor or the row can be up to 2.5 times the vertical-axis wind-turbine's rotor diameter downwind of the horizontal-axis wind-turbine.

The vertical-axis wind-turbine arrays are slightly downwind of the horizontal-axis wind-turbine array where the vertical-axis wind-turbines create a pressure difference between the front and back of the horizontal-axis wind-turbine rotor. This figure could also should a C shape where the vertical-axis wind-turbines at the edge of the row curve downwind similar to FIG. 8.

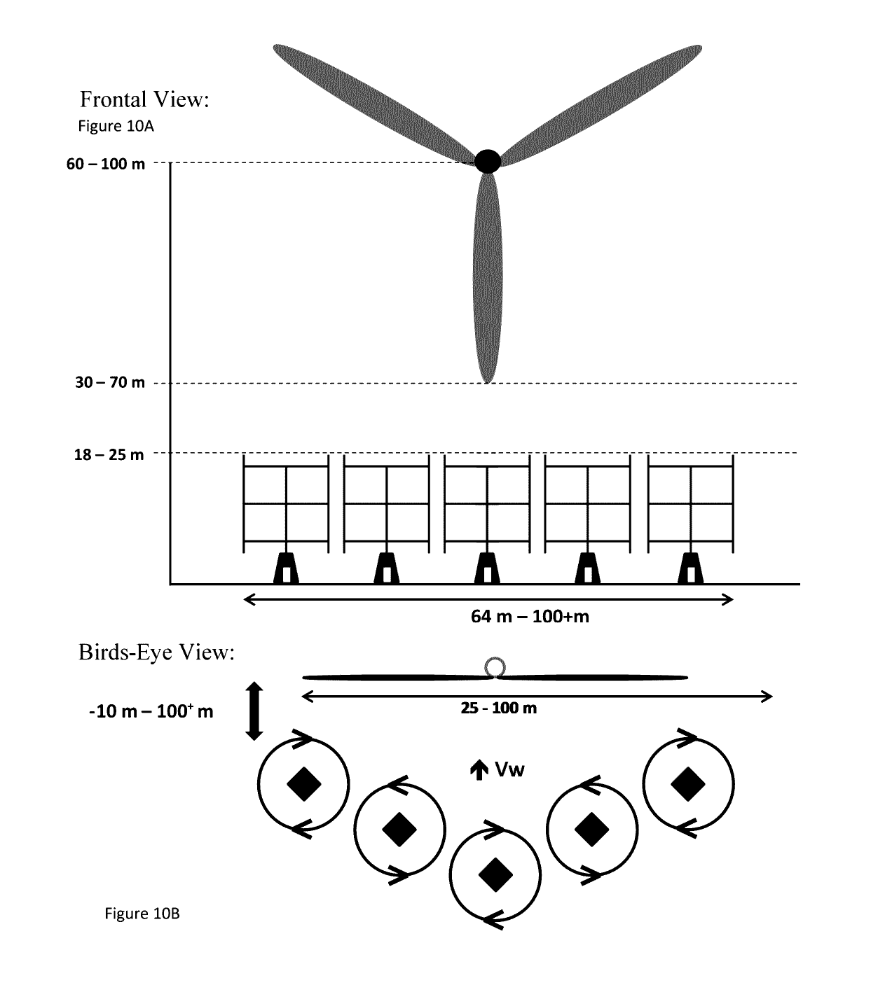

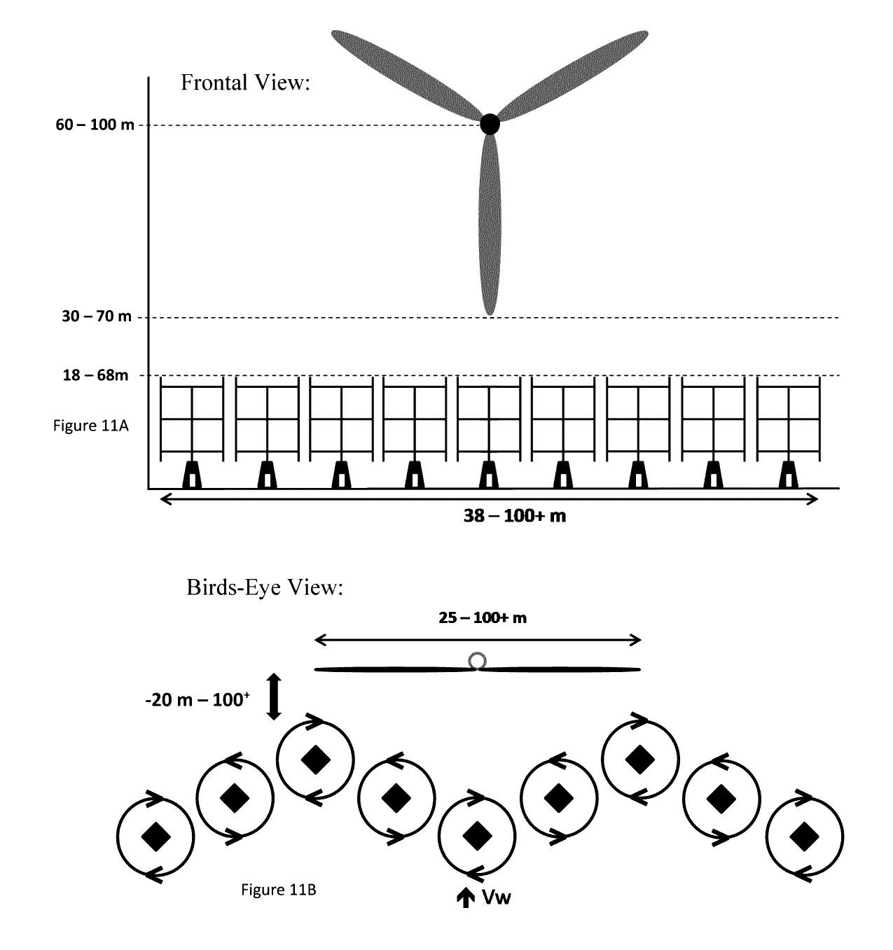

FIGS. 10A, 10B, 11A, and 11B illustrate diagrams of two example ways of many in which arrays of vertical-axis wind-turbines may be placed in a U or V or W shaped formations upwind or down wind of horizontal-axis wind-turbines.

In FIG. 10B, the vertical-axis wind-turbines in the V shaped array can extend out to 100 meters on each wing of the V. The point of the V shape can be many meters up front depending on whether the purpose is to create the porous wind fence effect or the plan form kinetic effect.

Likewise, in FIG. 11B, the M shaped array can produce the porous wind effect or the plan form kinetic flux effect.

The point(s) of the V, W or M part of the array may be upwind of the horizontal-axis wind-turbine while the “tails” of the vertical-axis wind-turbine arrays can extend downwind of the horizontal-axis wind-turbine tower. These arrangements may vary based on wind direction. When these arrays are under the horizontal-axis wind-turbine, the benefit to the horizontal-axis wind-turbines may come from the “porous wind fence” effect. Placed further upwind, these configurations of vertical-axis wind-turbine arrays may increase the wind speeds realized by the horizontal-axis wind-turbine because the vertical-axis wind-turbines create vertical mixing and planform kinetic flux.

In an embodiment, vertical-axis wind-turbines may be placed in arrays that form various V and W or M shaped formations (when seen from directly overhead) and curved variations of the same shaped formations in order to maximize the benefits of wind coming from different directions and reduce downwind turbulence or increase the wind speeds that are realized by downwind horizontal-axis wind-turbines and vertical-axis wind-turbines and horizontal-axis wind-turbines placed directly overhead of the vertical-axis wind-turbine array.

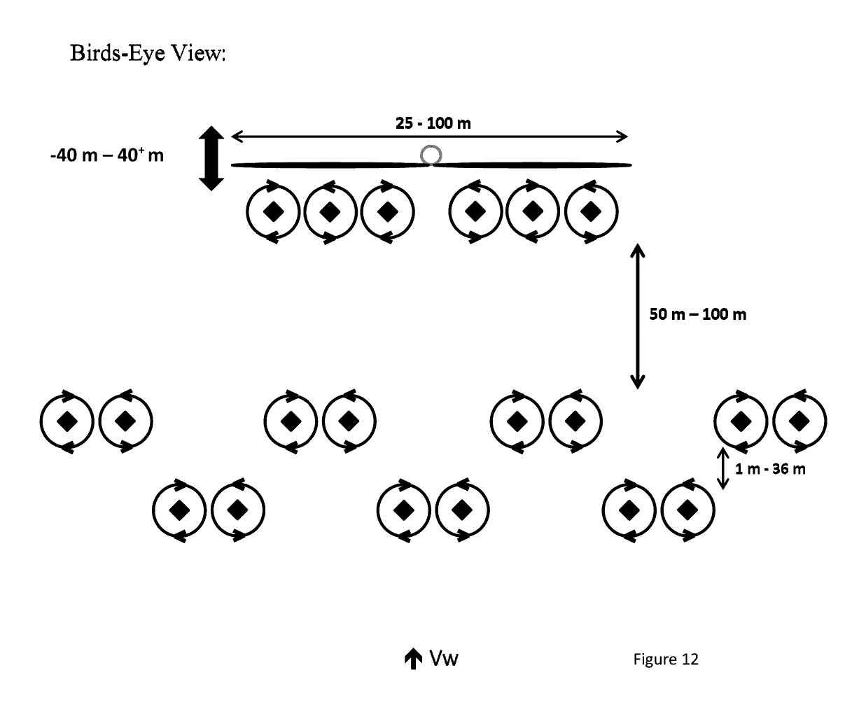

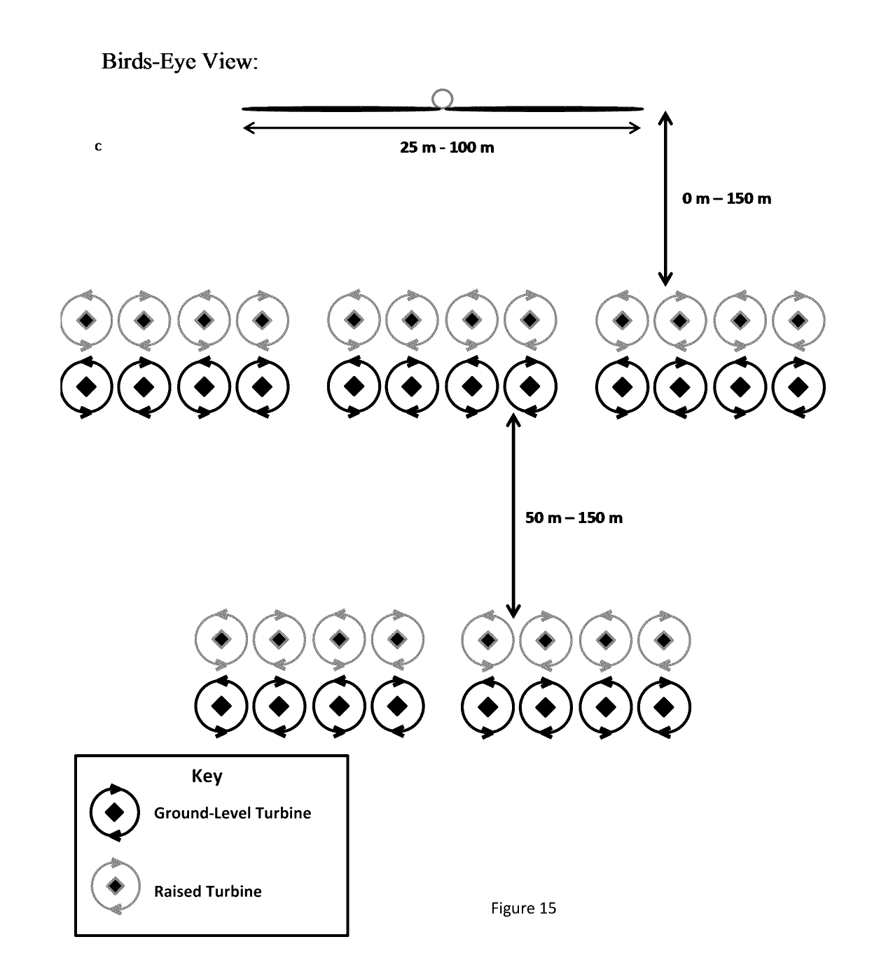

FIGS. 12 to 15 illustrate some examples in which coupled pairs of vertical-axis wind-turbines can increase the wind speeds realized by downwind horizontal-axis wind-turbines by creating vertical mixing and planform kinetic flux. These pairs of vertical-axis wind-turbines can be combined with various arrangement of vertical-axis wind-turbine arrays slightly in front, under or slightly downwind of the horizontal-axis wind-turbine rotor that induce the “porous wind fence” effect or the change in downwind pressure effect. The pairs of vertical-axis wind-turbines may have their blades rotating into or with the wind in the gap between their rotors. The vertical-axis wind-turbines may co-rotate or counter rotate. The vertical-axis wind-turbines may be in sets of pairs, threes, fours, or more in an array. There may be differing distances between the sets of vertical-axis wind-turbines in a row. The rows of vertical-axis wind-turbines may bend around the horizontal-axis wind-turbine to accommodate differences in the wind rose compass for the site or the topography. The rows of vertical-axis wind-turbines may include a shorter set of vertical-axis wind-turbines upwind of a set of vertical-axis wind-turbines on higher towers directly downwind of the shorter vertical-axis wind-turbines.

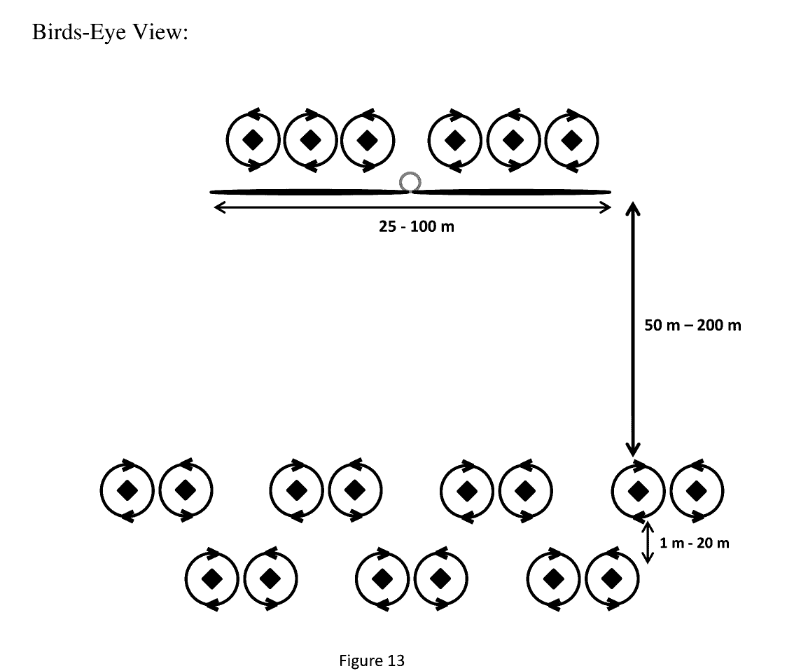

FIG. 13 shows an example where both the porous wind fence effect and the planform kinetic flux effect are working together. The vertical-axis wind-turbines in line with the horizontal-axis wind-turbine can also be placed downwind of the horizontal-axis wind-turbine to create the jet engine effect.

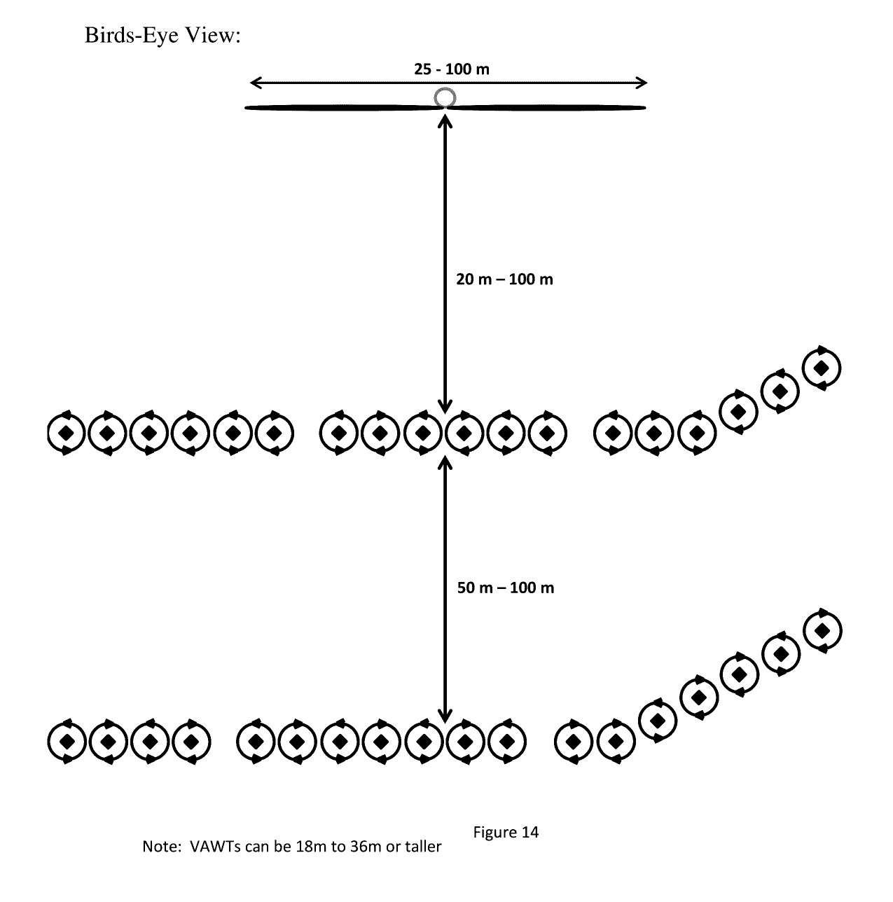

FIG. 14 shows multiple rows of vertical access wind turbines in front of a horizontal axis wind turbine. The set of vertical-axis wind-turbines create a coupled vortex effect of shed vortices by which higher altitude winds are brought closer to the ground. The rows of vertical access wind turbine are far enough distance away from the horizontal axis wind turbine that the main factor of increasing the driving torque on the horizontal axis wind turbine is primarily due to a vertical mixing affect. The vertical-axis wind-turbines shed vortices downwind to bring down higher altitude winds, which are generally higher in wind speed, closer to the ground. The wind has its speed from vertically mixed altitudes, which then blows on the horizontal access wind turbine that is located downwind of the vertical-axis wind-turbines. Each pair of vertical-axis wind-turbines couple at less than 0.5 rotor diameters. The rows of vertical access wind turbines may be coupled pairs, which are coupled to each other at less than 0.5 rotor diameter's within each pair. The 0.5 rotor diameter's distance or less is measured between the center of the rotor to the outside edge of blade.

Two or more rows of vertical-axis wind-turbines are placed upwind of the horizontal axis wind turbine. Sets of vertical access wind turbines in the first row close couple to pair with a neighboring vertical access wind turbine in order to create a coupled vortex effect. The coupled vortex effect has vortices shed downwind of the vertical-axis wind-turbines such that faster moving higher altitude winds are brought closer to the ground and the resulting wind speed that turns the rotor of the horizontal axis wind turbine is increased. The vertical access wind turbines are closely coupled at less than or equal to the radius of a rotor of the vertical-axis wind-turbines to the neighboring vertical access wind turbine. The radius of the rotor of the vertical axis wind turbine is measured between the center of its rotor and the outer edge of its blades.

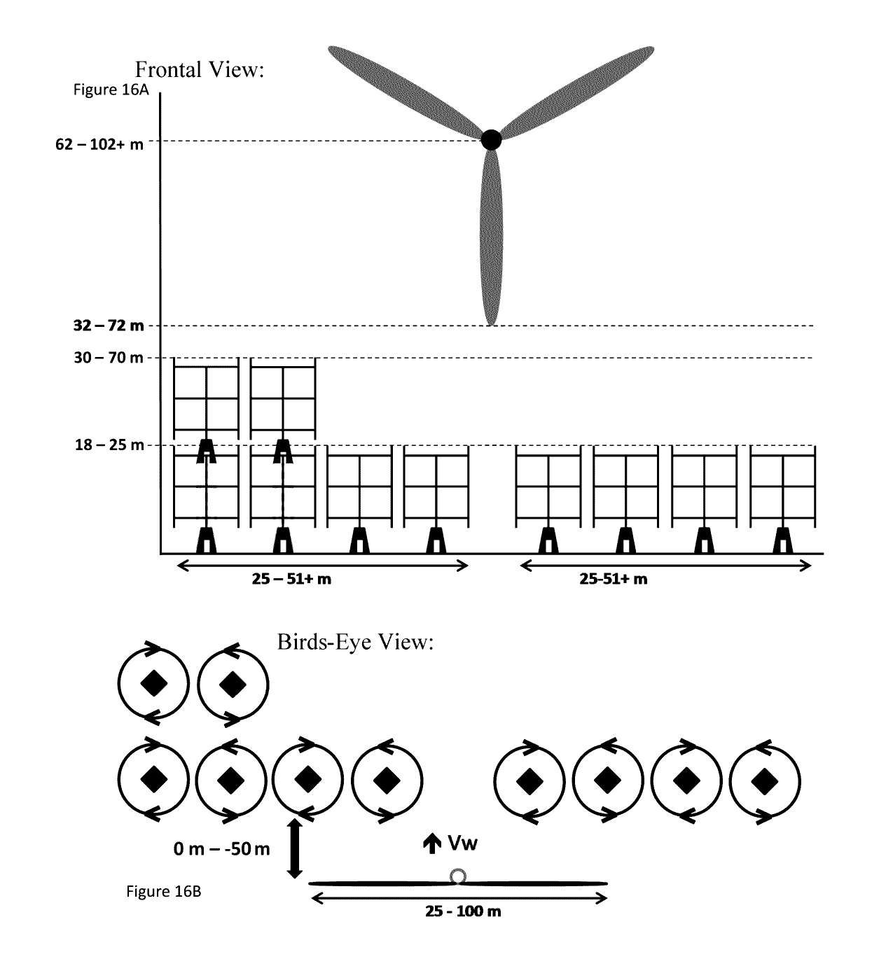

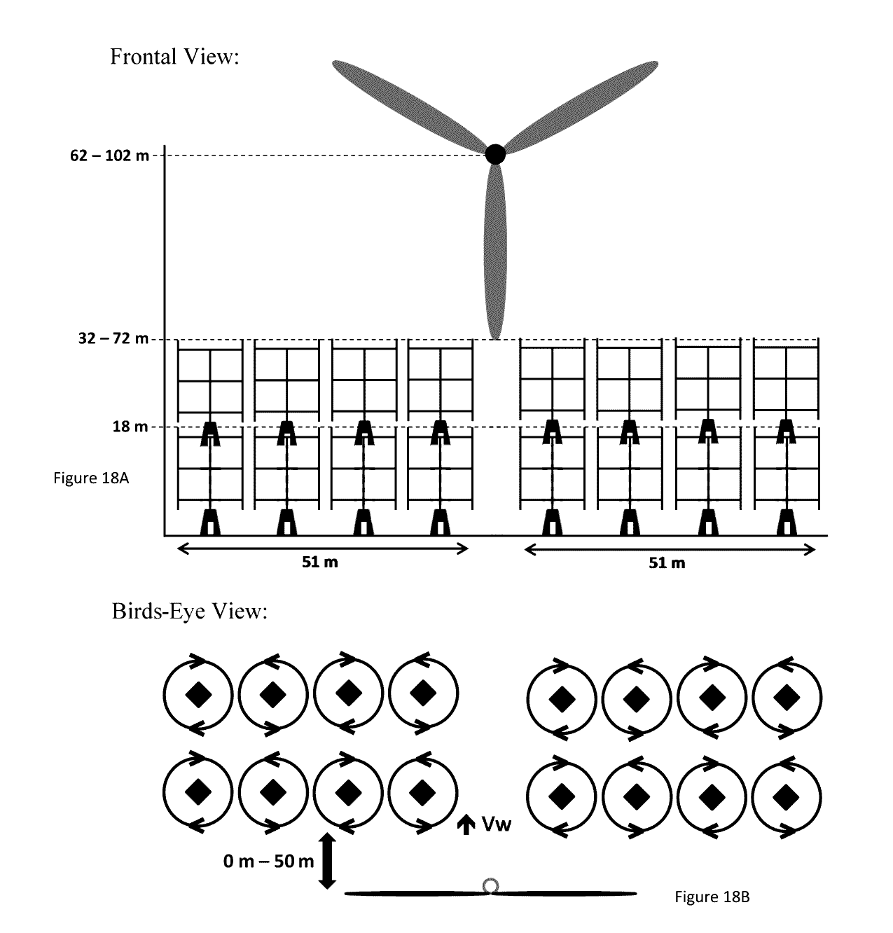

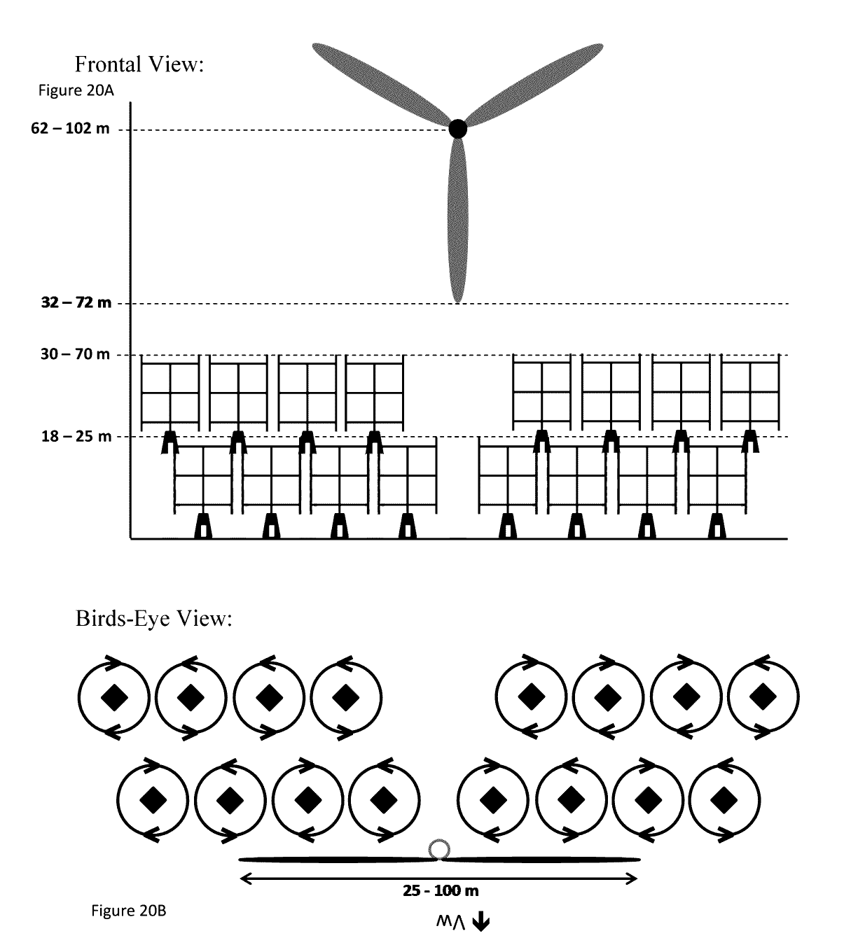

FIGS. 16A to 21 illustrate some examples of how vertical-axis wind-turbines can be placed directly downwind or under and close to a horizontal-axis wind-turbine to increase the wind speeds that the horizontal-axis wind-turbine rotor realizes. These variations exemplify the wide variations in which single and double rows of vertical-axis wind-turbine arrays can be installed to induce the porous wind fence effect, the planform kinetic flux effect, and the downwind speed up effect that increases the pressure difference upwind and downwind of the horizontal-axis wind-turbine. There can be double rows of arrays with the second row's rotors being higher and above the first row's rotors. One row of vertical-axis wind-turbines can be directly under or slightly upwind of the horizontal-axis wind-turbine rotor and the second, taller row of vertical-axis wind-turbines can be very close to the first row of vertical-axis wind-turbines. The rows of vertical-axis wind-turbines can curve and change based on how the wind rose compass of the site varies. The second row of taller vertical-axis wind-turbines can be directly behind the vertical-axis wind-turbines in front or can be in the middle of the vertical-axis wind-turbines in front. The single or double rows of vertical-axis wind-turbines can curve and be organized in set back pairs to accommodate different wind rose compasses for sites. The rows can be set up directly next to the horizontal-axis wind-turbine tower, slightly in front of behind.

FIGS. 16A and 16B show an example of a horizontal axis wind turbine with two or more rows of vertical-axis wind-turbines set behind the horizontal axis wind turbine from the perspective of the predominant direction of the wind blowing on the horizontal axis wind turbine. The horizontal axis wind turbine with one or more rows of vertical-axis wind-turbines set behind the horizontal axis wind turbine creates a speed up effect on the turning of the blade of the horizontal axis wind turbine due to a jet engine affect. The horizontal-axis wind-turbines creates a differential pressure behind the blade, which will then allow less friction that causes the blade of the horizontal axis wind turbine to turn faster.

The horizontal access wind turbine is aligned with at least one row of vertical-axis wind-turbines such that the row of vertical-axis wind-turbines are placed downwind of the horizontal axis wind turbine. The vertical-axis wind-turbines placed downwind of the horizontal-axis wind-turbines increase the speed of wind flowing through the upwind horizontal-axis wind-turbine's rotor by increasing the wind speed directly downwind of the horizontal-axis wind-turbine rotor through the “porous wind fence effect” of wind speeding up over the vertical-axis wind-turbine array. This increase in wind speed decreases the pressure on the back side of the horizontal-axis wind-turbine rotor; and thus, increases the pressure difference between the front side and back side of the horizontal-axis wind-turbine rotor, which increases the wind speed through the horizontal-axis wind-turbine rotor.

A first row of vertical-axis wind-turbines closer to the horizontal axis wind turbine is set as a lowest row of vertical axis wind turbine from the ground. A second row of vertical-axis wind-turbines farthest from the horizontal axis wind turbine is set as a highest row. The vertical-axis wind-turbines on taller towers can be placed upwind of shorter vertical-axis wind-turbines and increase the wind speeds realized by the shorter vertical-axis wind-turbines and create a different downwind wake and turbulence.

Different sized, heights and configured arrays of vertical-axis wind-turbines placed downwind of horizontal-axis wind-turbines may increase the speed of wind flowing through the upwind horizontal-axis wind-turbines' rotors by creating a greater pressure difference between the front and back of the horizontal-axis wind-turbine rotor and/or by other physical effects.

In an embodiment, arrays of vertical-axis wind-turbines of various heights, spacing and formations may be placed downwind and in close proximity of horizontal-axis wind-turbines to reduce downwind turbulence or increase the wind speeds that are realized by the upwind horizontal-axis wind-turbines.

Note, in an embodiment, the taller vertical-axis wind-turbines behind the row of shorter vertical-axis wind-turbines may be in any section with the determination based on wind direction and other factors. There may be more than two rows that are aligned.

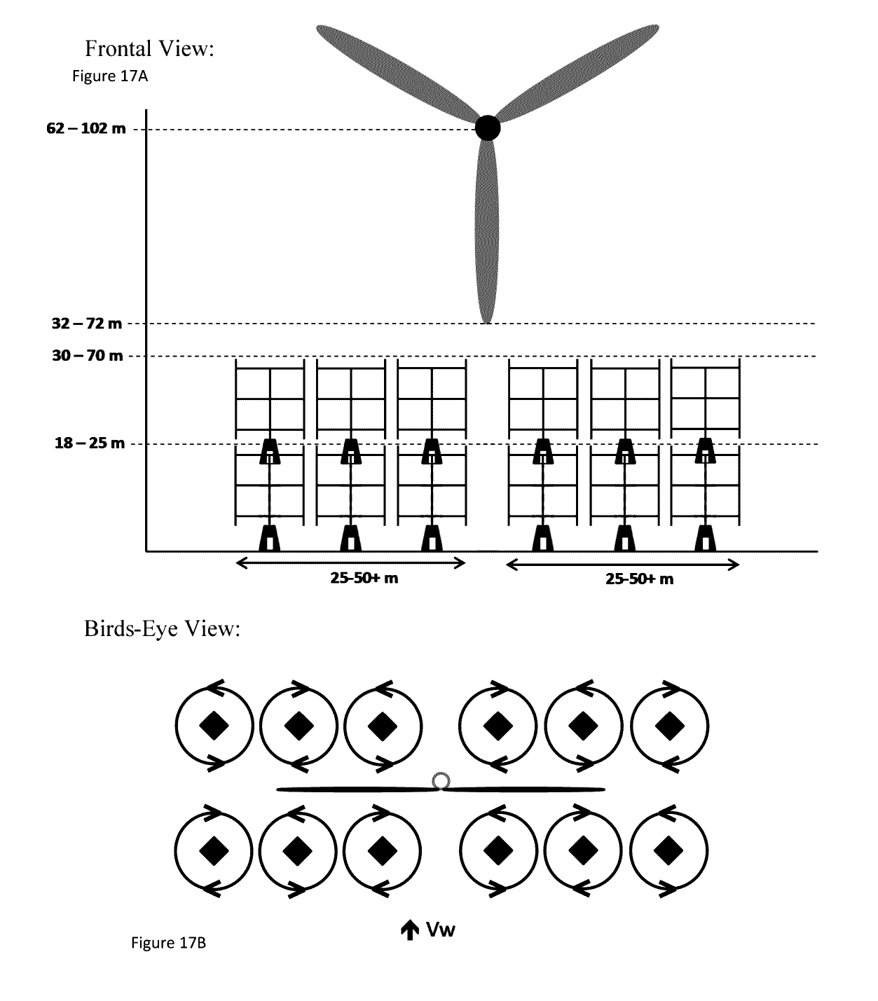

FIGS. 17A and 17B show an embodiment where a gap between sets of turbines may be placed in the rows of upwind and downwind vertical-axis wind-turbine arrays. The rows of upwind and downwind vertical-axis wind-turbine arrays also may vary in height in order to reduce downwind turbulence or increase the wind speeds that are realized by downwind horizontal-axis wind-turbines and/or vertical-axis wind-turbines.

In an embodiment, the turbine support structures of the vertical-axis wind-turbines are positioned such that a corner or aside faces into the prevailing wind and it may have a cover that may be aerodynamically shaped in order to minimize downwind turbulence or increase the wind speeds realized by its own rotor or downwind or upwind vertical-axis wind-turbines and vertical mixing of wind realized by horizontal-axis wind-turbines. Such support structures to tall vertical-axis wind-turbines can be placed within one-half of one rotor diameter to the passing blades of shorter vertical-axis wind-turbines beneath them to change the physics of how the wind flows into and out from the gap created between the support structure and the closely passing blades of the vertical-axis wind-turbines below.

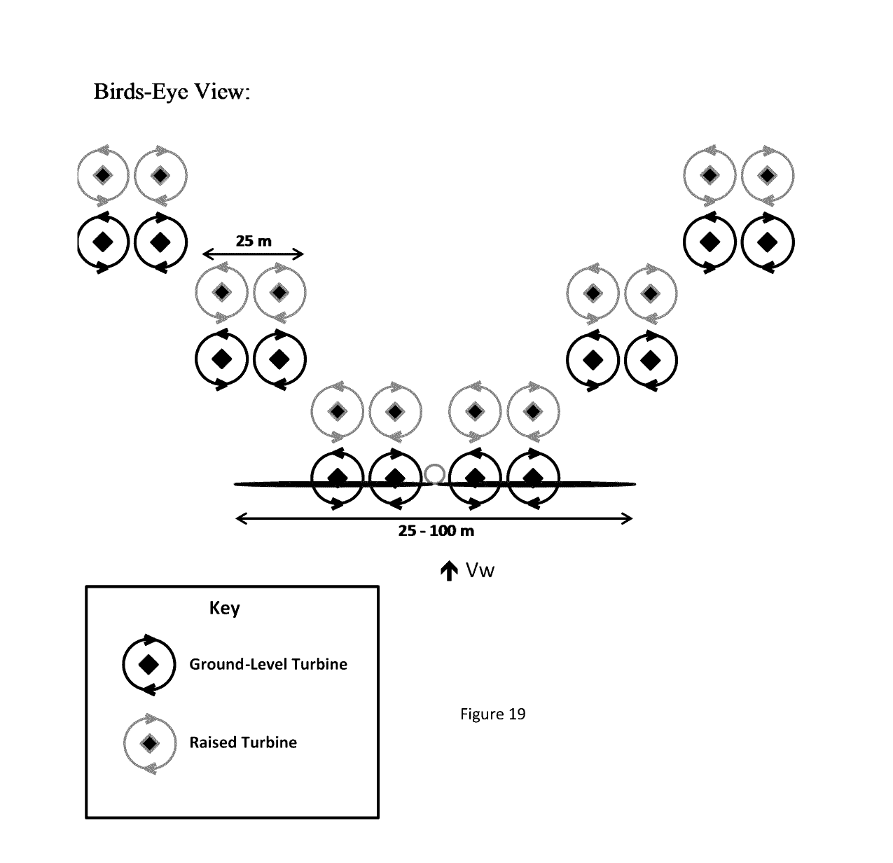

FIG. 19 shows an example of a horizontal axis wind turbine with two or more rows of vertical-axis wind-turbines set behind the horizontal axis wind turbine. Each row of vertical-axis wind-turbines set behind the horizontal axis wind turbine is taller and creates a greater differential pressure behind the blade. Each row of vertical-axis wind-turbines is offset to the wind direction that is coming at the horizontal axis wind turbine. The wind primarily driving the turbine comes from multiple angles. The alignment of the rows of vertical access wind turbines correspond to these different angles.

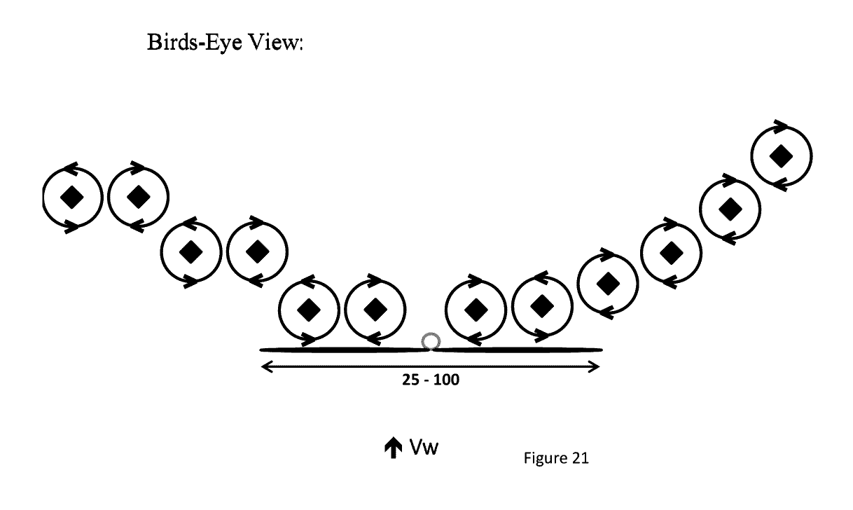

FIG. 21 shows a configuration of vertical-access wind-turbines that can have a set be set immediately upwind, underneath, and/or downwind of the horizontal-axis wind-turbine based on the predominant wind direction. The configuration of vertical-access wind-turbines is designed to accommodate the differences in the wind rose compass of the site, and the desire of the wind farm developer to account for topography and the planform kinetic flux potential of the wind farm.

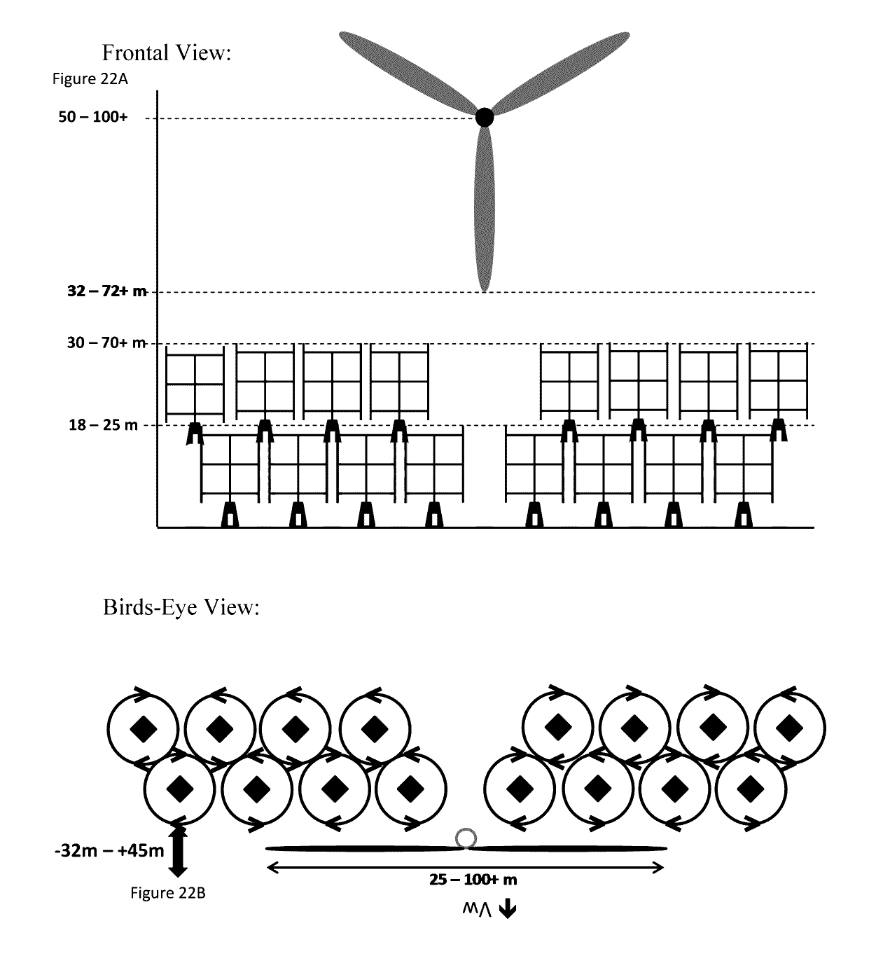

FIGS. 22A and 22B illustrate a diagram of an embodiment of how vertical-axis wind-turbines on taller towers can be placed in the gaps between vertical-axis wind-turbines on shorter towers where the taller tower could force the confinement of the wind speed behind the upwind vertical-axis wind-turbines and increase the speed of the wind through the confined area and into the taller vertical-axis wind-turbines. The second row of vertical-axis wind-turbines can overhang the first row of vertical-axis wind-turbines to create different downwind dynamics.

Note, the two or more rows of vertical-axis wind-turbines are also set extremely close and have coupling at less than a half diameter of the blade of the turbine. The second row of vertical-axis wind-turbines can overhang the first row of vertical-axis wind-turbines to create different downwind dynamics.

FIG. 22 also shows a configuration where the wind from the opposite direction would have the taller turbines upwind of the shorter vertical-axis wind-turbines. This upwind position may result in better overall array efficiencies and have a larger impact on the increase of wind speed over the top of the vertical-axis wind-turbine arrays and thus the wind speeds realized by the horizontal-axis wind-turbines. This same “off set” configuration could be used to increase planform kinetic flux, downwind vertical mixing and the increased wind speeds realized by horizontal-axis wind-turbines.

In an embodiment, vertical-axis wind-turbines may be placed within a half a rotor diameter from the base of a horizontal-axis wind-turbine tower with its blades rotating with or into the wind next to the horizontal-axis wind-turbine tower in order to realize increased wind speed on the vertical-axis wind-turbines nearest the tower as the wind may compress and speed up between the tower and the vertical-axis wind-turbine.

A vertical axis wind turbine may be placed close to a tower of the horizontal-axis wind-turbine such that the blades of the vertical axis wind turbine pass at a distance from the tower equal to or less than a radius of the vertical axis wind turbine rotor. The resulting gap created by the placement increases the wind speed creating lift on the turbine blade of the vertical axis wind turbine.

Overall discussed herein have been many examples of different implementations that include variation in:
sizes, shape and heights of vertical-axis wind-turbine rotors, blades, and support structures,
sizes, lengths, shapes and number of blades of nearby horizontal-axis wind-turbines,
horizontal-axis wind-turbine or vertical-axis wind-turbine solidities and heights above ground,
distances between individual vertical-axis wind-turbines and pairs of vertical-axis wind-turbines in an array,
vertical-axis wind-turbine or horizontal-axis wind-turbine fairings and blade tip sizes and shapes,
the angles that vertical-axis wind-turbine arrays are placed to the prevailing wind,
turbine rotational speeds, and
the presence of, shape of and height of external support structures for vertical-axis wind-turbine rotors.

In an embodiment, arrays of vertical-axis wind-turbines of various heights, spacing and formations may be placed in different configurations of heights, spacing and formations to reduce harm to flying animals.

In an embodiment, arrays of vertical-axis wind-turbines can be installed where the placement of external support towers for large rotors can benefit the output of their own rotors, benefit downwind horizontal-axis wind-turbines, and/or decrease the amount of steel and foundations needed per rotor swept area installed.

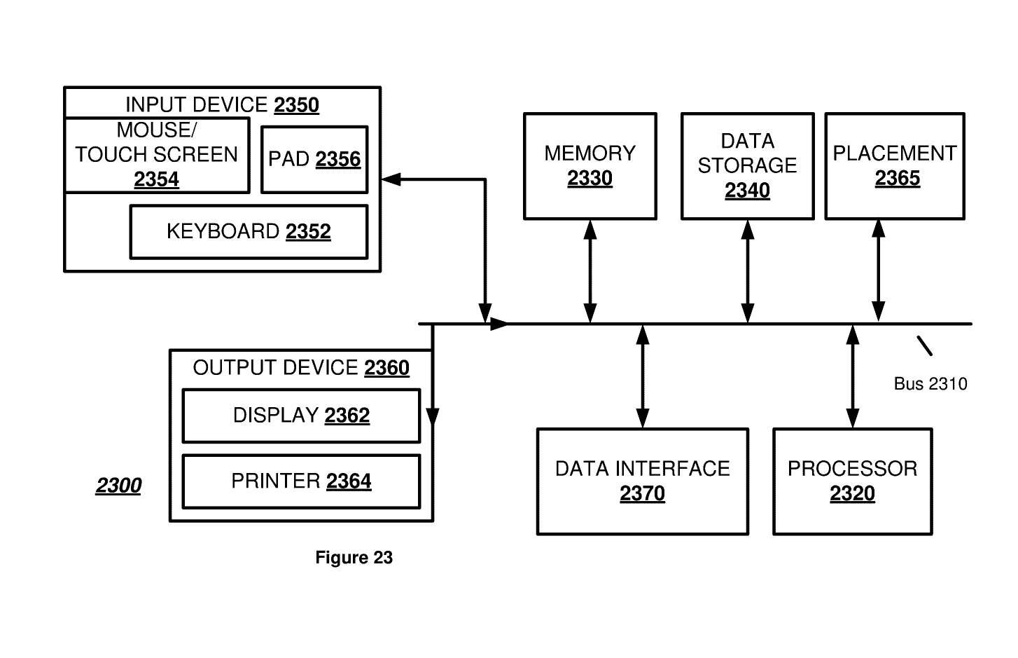

FIG. 23 illustrates, in a block diagram, an embodiment of a computing device to assist in the placement of one or more rows of vertical-axis wind-turbines in a plot of land.

The exemplary computing device 2300 may act as an automatic wind turbine placement device. The computing device 2300 may combine one or more of hardware, software, firmware, and system-on-a-chip technology to implement an automatic wind turbine placement device. The computing device 2300 may include a bus 2310, a processor 2320, a memory 2330, a data storage 2340, an input device 2350, an output device 2350, and a data interface 2370. The bus 2310, or other component interconnection, may permit communication among the components of the computing device 2300. A placement module 2365 cooperates with the above components to place the turbines.

The processor 2320 may include at least one conventional processor or microprocessor that interprets and executes a set of instructions. The memory 2330 may be a random access memory (RAM) or another type of dynamic data storage that stores information and instructions for execution by the processor 2320. The memory 2330 may also store temporary variables or other intermediate information used during execution of instructions by the processor 2320. The data storage 2340 may include a conventional ROM device or another type of static data storage that stores static information and instructions for the processor 2320. The data storage 2340 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computing device-readable media as described herein is distinguishable from having instructions propagated or transmitted, as the propagation transfers the instructions, versus stores the instructions such as can occur with a computing device-readable medium having instructions stored thereon. Therefore, unless otherwise noted, references to computing device-readable media/medium having instructions stored thereon, in this or an analogous form, references tangible media on which data may be stored or retained. The data storage 2340 may store a set of instructions detailing a method that when executed by one or more processors cause the one or more processors to perform the method. The data storage 2340 may also be a database or a database interface.

The input device 2350 may include one or more conventional mechanisms that permit a user to input information to the computing device 2300, such as a keyboard 2352, a mouse 2354, a voice recognition device, a microphone, a headset, a touch screen, a touch pad 2356, a gesture recognition device, etc. The output device 2360 may include one or more conventional mechanisms that output information to the user, including a display 2362, a printer 2364, one or more speakers, a headset, or a medium, such as a memory, or a magnetic or optical disk and a corresponding disk drive. The data interface 2370 may include any transceiver-like mechanism that enables computing device 2300 to communicate with other devices or networks. The data interface 2370 may include a network interface or a transceiver interface. The data interface 2370 may be a wireless, wired, or optical interface.

The computing device 2300 may perform such functions in response to processor 2320 executing sequences of instructions contained in a computing device-readable medium, such as, for example, the memory 2330, a magnetic disk, or an optical disk. Such instructions may be read into the memory 2330 from another computing device-readable medium, such as the data storage 2340, or from a separate device via the data interface 2370.

An embodiment may be implemented in a network environment with one or more servers and databases as well as one or more remote nodes.

The computing device 2300 with the placement module 2365 may implement a software assisted method of placing vertical-axis wind-turbines in a land plot to generate a three dimensional contour map representing the optimal placing and arrangement of each of the individual vertical-axis wind-turbines on the plot of land in order to produce the optimum amount of electrical power output for the plot of land. In an embodiment, an automatic wind turbine placement device may include a data interface, a processor, a display, a placement module, and software resident within the device. The data interface is configured to receive a turbine parameter set. The processor is configured to cooperate with the placement module to calculate an optimal vertical-axis wind-turbine placement for the land plot to maximize electrical power production and apply the optimal vertical-axis wind-turbine placement to the land plot description. A user input is configured to receive a user placement of a member vertical-axis wind-turbine of the set of vertical-axis wind-turbines. The display may present the optimal vertical-axis wind-turbine placement as a three dimensional contour map describing the optimal vertical-axis wind-turbine placement in relation to the land plot to a user. The software has an objective to optimize the power output of a number of vertical-axis wind-turbine's on any specified plot of land. In an embodiment, a non-transitory, tangible, machine-readable, storage device may be configured to store a set of instructions detailing a method stored thereon that when executed by one or more processors cooperating with the placement module to cause the one or more processors to perform the method.

The method factors a turbine parameter set describing 1) one or more vertical-axis wind-turbine arrays with 2) one or more horizontal-axis wind-turbines, 3) a land parameter set describing a land plot, and 3) a land constraint parameter set for the land plot. The method analyses for the vertical-axis wind-turbine array of 1) the power curves of the wind turbines concerned; 2) the turbine's coupled vortex models, i.e. power increase as function of distance between turbines and wind direction; 3) the turbine's wake coefficient models giving wake smoothness over distance and topography; 4) maximum number of vertical-axis wind-turbines in an array of vertical-axis wind-turbines; 5) the distance between arrays in a row of vertical-axis wind-turbines, and 6) other similar factors. The method analyses for the land parameter set for 1) the precise location and elevation of the plots of land; 2) the wind rose (direction over a year) and average wind speeds for the plot of land; 3) the contour map of the plot of land; 4) the “roughness factor” for the land and 5) other similar factors. The multiple algorithms of the placement software are configured to optimize the power output of the wind farm on the plot of land or individual arrays or groups of arrays in question. The method may also factor a wind interaction between one or more horizontal-axis wind-turbines and one or more vertical-axis wind-turbines in the set and vice versa. The method applies optimal vertical-axis wind-turbine placements to the land plot description. The method presents an output land plot description describing optimal vertical-axis wind-turbine placements in relation to the land plot to a user. Thus, the three dimensional map outlines the optimal positioning of the individual turbines to produce the different power outputs for the plot of land based on the Return on Investment desired. The method displays a three dimensional contour map representing the optimal vertical-axis wind-turbine placement of the vertical-axis wind-turbine arrays. The method also displays an expected resulting power and energy output for the optimal wind turbine placement. The method may then receive a user's input placement of a member vertical-axis wind-turbine of the vertical-axis wind-turbine array. The method gives the ability for a user to remove or add turbines, or manually drag a specific turbine to a new location and make other changes. The method recalculates a resulting power and energy output for the optimal wind turbine placement based on the user's input placement of the member vertical-axis wind-turbine of the vertical-axis wind-turbine array. Thus, individual turbines can be moved around on the map and the total power and energy output effect can be shown in order to see the effect of optimizing placement to existing connection points to the grid or other constraints like rivers or sharp contour features that do not allow a practical placement of a vertical-axis wind-turbine.

The software is configured with algorithms and routines to maximize the amount of power density that a given plot of land will produce or the profitability of an investment in only the most productive of the vertical-axis wind-turbines for a wind farm based on factors including the geographic contour map of that plot of land, the wind shape of the land, potentially multiple wind directions occurring within the plot of land, placement constraints of existing objects on the land, including rivers and/or horizontal-axis wind-turbines, property boundary lines defining boundaries of the land's location, a power curve of the turbines, a wake coefficient for the turbines, the land's elevation to sea level, an average wind speed for two or more distinct areas within that plot of land, and one or more landmark features or building structure features on the plot of land that act as a land constraint for placement and affecting wind speed and direction on that limited land area of the plot of land, and other factors.

The software and its routines and algorithms generally at least pair two vertical-axis wind-turbines together in and array in order create the coupled vortex effect, or wind wall effect, or greater pressure on the front side to backside of a horizontal axis wind turbine, or any combination of these, which result in a higher power production in both of those turbines. The algorithm also tries to optimize in one instance the intermixing of the placement of rows and different configurations of vertical-axis wind-turbine arrays with rows of the existing horizontal-axis wind-turbines. The algorithms take into account both placing a given amount of vertical-axis wind-turbines on a plot of land and maximizing the efficiency of the placed vertical-axis wind-turbines on that plot of land based on, among other things, the wind direction, turbine and array solidities, and wake effects of arrays on down vertical-axis wind-turbines and horizontal-axis wind-turbines, and wind acceleration effects of land topographical features. The algorithms also try to take into account the beneficial effects of how different patterns of vertical-axis wind-turbines can create vertical mixing and/or the “wall acceleration effect” such that downwind horizontal-axis wind-turbines realize more air flow through their rotors. The algorithms take into account that the geography of the land may not all be flat; and thus, have contours of hills and ridges to affect the wind flow and direction of wind on that plot of land.

Vertical-axis wind turbines may be used to ‘in-fill’ the understory of wind farms. Vertical-axis wind turbines may be geographically placed in a specific array and orient those arrays with beneficial power effects. Multiple arrays of vertical-axis turbines may be intermixed with existing horizontal axis turbines to increase the power density of a wind farm per acre and potentially increase the energy output of the horizontal-axis wind-turbines in the wind farm. Integration of the vertical-axis turbines with existing wind farm acreage increases the power density of that wind farm.

One or more rows of vertical-axis wind-turbines are placed in the current high wind, existing open land between existing rows of horizontal-axis wind-turbines (tall wind turbines) in a wind farm. Inserting vertical-axis wind-turbines creates electrical generating revenue in non-revenue producing land for Wind Farm developers.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computing device-readable storage media for carrying or having computing device-executable instructions or data structures stored thereon. Such computing device-readable storage media may be any available media that can be accessed by a general purpose or special purpose computer. By way of example, and not limitation, such computing device-readable storage media can comprise RAM, ROM, EEPROM, CD-ROM or other optical disk storage, magnetic disk storage or other magnetic data storages, or any other medium which can be used to carry or store desired program code means in the form of computing device-executable instructions or data structures. Combinations of the above should also be included within the scope of the computing device-readable storage media.

Embodiments may also be practiced in distributed computing environments where tasks are performed by local and remote processing devices that are linked (either by hardwired links, wireless links, or by a combination thereof) through a communications network.

Computing device-executable instructions include, for example, instructions and data, which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computing device-executable instructions, associated data structures, and program modules represent examples of the program code means for executing steps of the methods disclosed herein. The particular sequence of such executable instructions or associated data structures represents examples of corresponding acts for implementing the functions described in such steps.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry.

Although the above description may contain specific details, they should not be construed as limiting the claims in any way. Other configurations of the described embodiments are part of the scope of the disclosure. For example, the principles of the embodiments herein may be applied to each individual user where each user may individually deploy such a system. This enables each user to utilize the benefits of the embodiments herein even if anyone of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A system, comprising,
two or more vertical-axis wind-turbines of a same or differing heights are aligned in a geometric array relative to a horizontal axis wind turbine, where the two or more vertical-axis wind-turbines are placed in close proximity to the horizontal axis wind turbine, where both the vertical-axis wind-turbines and the horizontal axis wind turbine are in close enough proximity to each other to have an effect on wind conditions that create lift on a turbine blade and turn the rotor of the horizontal axis wind turbine, where the wind conditions caused by the two or more vertical-axis wind-turbines include any of i) a wind wall effect to create multiple zones of wind conditions, above a height of and on each side of the vertical-axis wind-turbines, that cause the effect on the wind conditions that create lift on a turbine blade and turn the rotor of the horizontal axis wind turbine, ii) a pressure difference between a front side and a back side of the rotor of the horizontal axis wind turbine, any combination of the two, where the vertical-axis wind-turbines and horizontal axis wind turbine are configured to use the wind conditions to convert wind into increases in generated electrical power.

2. The system of claim 1, where the horizontal axis wind turbine is aligned with a row of vertical-axis wind-turbines such that the row of vertical-axis wind-turbines are placed any of i) centerline with and ii) upwind of the horizontal axis wind turbine, where a set of vertical-axis wind-turbines in the row are each paired with a neighboring vertical axis wind turbine, where the vertical-axis wind-turbines placed any of i) centerline with and ii) upwind of the horizontal axis wind turbine create the wind walls that force wind to speed up over the top of and around the vertical-axis wind-turbines and increase the speed of the wind that effects the blades of the horizontal axis wind turbine, where the wind wall creates two zones, where a first zone of wind caused at the tops and sides of the vertical-axis wind-turbines forming the wind wall is a turbulence zone in which the blade of the horizontal axis wind turbine can be adversely affected due to the turbulent wind when the blade of the horizontal axis wind turbine enters into this turbulence zone, where a second zone of affected wind due to the wind wall is above or on the side of the turbulence zones and is a speed zone where in the speed zone the wind speed is increased for wind directly overhead or downwind or on the side of the wind wall but the turbulence is not substantially increased, where when the blade of the horizontal axis wind turbine extends and enters into this speed zone, then a force causing lift on the blade is effected by the increased wind speed in this second zone.

3. The system of claim 1, where the vertical-axis wind-turbines are also aligned in two or more rows at different heights, where the vertical-axis wind-turbines are placed upwind to a location of a column supporting the rotor and blades of the horizontal axis wind turbine, where a first row of vertical-axis wind-turbines closer to the horizontal axis wind turbine is set as a highest row of vertical axis wind turbine from the ground, where a second row of vertical-axis wind-turbines farthest from the horizontal axis wind turbine is set as a shortest row, where the highest row of vertical-axis wind-turbines is placed downwind the shortest row of vertical axis wind turbine and benefits from the increased wind speed that flows past and over the top of the shortest row the vertical-axis wind-turbines; and thus, the wind wall effect created by the second row of vertical-axis wind-turbines creates a greater combined increase of a velocity of the wind than produced by merely the shortest row of vertical-axis wind-turbines by itself.

4. The system of claim 1, where the vertical-axis wind-turbines are also aligned in a curved row of aligned vertical-axis wind-turbines to create the wind wall effect because free blowing wind primarily driving the blade of the horizontal axis wind turbine comes from two or more different angles at the horizontal axis wind turbine, where the alignment of the curved row of vertical-axis wind-turbines correspond to these different angles, where the curved row of aligned vertical-axis wind-turbines are shaped to maximize benefits of the wind coming from different directions and increase the wind speeds that are realized by the downwind or overhead rotor of the horizontal axis wind turbine.

5. The system of claim 1, where the horizontal axis wind turbine is aligned with a row of vertical-axis wind-turbines such that the row of vertical-axis wind-turbines are placed downwind of the horizontal axis wind turbine, where the vertical-axis wind-turbines placed downwind of the horizontal axis wind turbine increase the speed of wind flowing through the upwind horizontal axis wind turbine's rotor by creating a greater pressure difference between the front side and back side of the horizontal axis wind turbine.

6. The system of claim 1, where the horizontal axis wind turbine is aligned with two or more rows of vertical-axis wind-turbines such that the vertical-axis wind-turbines are placed behind the horizontal axis wind turbine from a perspective of a predominant direction of the wind blowing on the horizontal axis wind turbine, where the two or more rows of vertical-axis wind-turbines set behind the horizontal axis wind turbine create a speed up effect on the turning of the blade of the horizontal axis wind turbine due to creating a greater differential pressure between the front side of the horizontal axis wind turbine and the back side of the horizontal axis wind turbine, where a first row of vertical-axis wind-turbines closer to the horizontal axis wind turbine is set as a lowest row of vertical axis wind turbine from the ground, where a second row of vertical-axis wind-turbines farthest from the horizontal axis wind turbine is set as a highest row.

7. The system of claim 1, where the vertical-axis wind-turbines aligned in a row have two or more sets of vertical-axis wind-turbines set at different heights within that row, where a first set of or single vertical-axis wind-turbines is higher from the ground than a second set of or single vertical-axis wind-turbines in that row, where each different set of vertical-axis wind-turbines at the different heights forms its own wind wall and corresponding multiple zones of wind to affect the turbine blades and rotor of the horizontal axis wind turbine.

8. The system of claim 7, where the second set of vertical-axis wind-turbines in that row is closer to a centerline of a column supporting the horizontal axis wind turbine and the first set of vertical-axis wind-turbines is farther from the centerline of the column supporting the horizontal axis wind turbine, where the multiple zones include a turbulence zone and a speed zone, where the different heights of the wind walls formed benefit the blades of the horizontal axis wind turbine as they rotate circularly across the width of the row of vertical-axis wind-turbines, where the speed zone of wind boosts wind speed and increases the lift and torque on the turbine blades as they go through their circular circumference motion on the horizontal axis wind turbine.

9. The system of claim 1, where one or more rows of counter rotating and/or co-rotating vertical-axis wind-turbines are placed upwind of the horizontal axis wind turbine, where a first vertical axis wind turbine close couples to pair with a neighboring vertical axis wind turbine in a first row to create a coupled vortex effect where vortices are shed downwind of the vertical-axis wind-turbines such that faster moving higher altitude winds are brought closer to the ground and resulting wind speed that turns the rotor of the horizontal axis wind turbine is increased, where the first vertical axis wind turbine and the neighboring vertical axis wind turbine are closely coupled in a co-rotating or counter rotating position at less than or equal to a radius of a rotor of the vertical-axis wind-turbines, where the radius of the rotor of the vertical axis wind turbine is measured between a center of its rotor and an outer edge of its blades.

10. The system of claim 1, where the vertical-axis wind-turbines are paired with a neighboring vertical axis wind turbine within a row of vertical-axis wind-turbines, where each pair of vertical-axis wind-turbines has blades that are counter-rotating with respect to a first neighboring vertical axis wind turbine or are co-rotating with respect to a second neighboring vertical axis wind turbine, where the counter-rotating blades and co-rotating blades of the neighboring vertical-axis wind-turbines are set in closely placed configurations where the neighboring blades pass by each other at a distance equal to or less than the radius of one of their rotors and at differing heights in a row so that downwind vertical mixing of the wind is increased and rows of vertical-axis wind-turbines downwind can be placed closer to upwind rows of vertical-axis wind-turbines without realizing loss of energy production by the downwind vertical-axis wind-turbines, and where turbulence that could reach the rotors of horizontal-axis wind-turbines is reduced and the wind speed entering the rotors of the horizontal-axis wind-turbines is increased.

11. A method of placing vertical-axis wind-turbines within a wind farm, comprising:
placing two or more vertical-axis wind-turbines aligned in a geometric array relative to a horizontal axis wind turbine,
placing the two or more vertical-axis wind-turbines in close proximity to the horizontal axis wind turbine, and
setting both the vertical-axis wind-turbines and the horizontal axis wind turbine in close enough proximity to each other to have an effect on wind conditions that create lift on a turbine blade and turn the rotor of the horizontal axis wind turbine, where the wind conditions caused by the two or more vertical-axis wind-turbines include any of i) a wind wall effect to create multiple zones of wind conditions, above a height of and on each side of the vertical-axis wind-turbines, that cause the effect on the wind conditions that turn the turbine blade and rotor of the horizontal axis wind turbine, ii) a pressure difference between a front side and a back side of the turbine blade of the horizontal axis wind turbine, iii) any combination of the two, where the vertical-axis wind-turbines and horizontal axis wind turbine are configured to use the wind conditions to convert wind into increases in generated electrical power.

12. The method of claim 11, further comprising:
placing the vertical-axis wind-turbines aligned in a row with the horizontal axis wind turbine such that the row of vertical-axis wind-turbines are placed any of i) centerline with and ii) upwind of the horizontal axis wind turbine, where a set of vertical-axis wind-turbines in the row are each paired with a neighboring vertical-axis wind-turbine,
placing the vertical-axis wind-turbines any of i) centerline with and ii) upwind of the horizontal axis wind turbine in order to create the wind walls that force wind to speed up over the top of and around the vertical-axis wind-turbines and increase the speed of the wind that affects the downwind or overhead blades of the horizontal axis wind turbine, where the wind wall creates two zones, where a first zone of wind caused at the tops and on the sides of the vertical-axis wind-turbines forming the wind wall is a turbulence zone in which the blade of the horizontal axis wind turbine can be adversely affected due to the turbulent wind when the blade of the horizontal axis wind turbine enters into this turbulence zone, where a second zone of affected wind due to the wind wall is above or on the side of the turbulence zone and is a speed zone, where in the speed zone the wind speed is increased for wind immediately above, on the side or downwind of the wind wall but the turbulence is not substantially increased, where in the speed zone the wind speed is increased, and when the blades of the horizontal axis wind turbine rotate into and enter into this speed zone, then a force creating lift on the blade is affected by the increased wind speed in this second zone.

13. The method of claim 11, further comprising:
placing the vertical-axis wind-turbines aligned in two or more rows at different heights, where the vertical-axis wind-turbines are placed upwind to a location of a tower supporting the rotor and blades of the horizontal axis wind turbine, where a first row of vertical-axis wind-turbines closer to the horizontal axis wind turbine is set as a highest row of vertical axis wind turbine from the ground, where a second row of vertical-axis wind-turbines farthest from the horizontal axis wind turbine is set as a shortest row, where the highest row of vertical-axis wind-turbines is placed downwind of the shortest row of vertical axis wind turbine and benefits from the increased wind speed that flows past and over the top of the shortest row the vertical-axis wind-turbines; and thus, the wind wall effect created by the highest row of vertical-axis wind-turbines creates a greater combined increase of a velocity of the wind than produced by merely the shortest row of vertical-axis wind-turbines by itself.

14. The method of claim 11, further comprising:
placing the vertical-axis wind-turbines aligned in a curved row of aligned vertical-axis wind-turbines to create the wind wall effect because free blowing wind primarily driving the blade of the horizontal axis wind turbine comes from two or more different angles at the horizontal axis wind turbine, where the alignment of the curved row of vertical-axis wind-turbines correspond to these different angles, where the curved row of aligned vertical-axis wind-turbines are shaped to maximize benefits of the wind coming from different directions and increase the wind speeds that are realized by the downwind and/or overhead rotor of a horizontal axis wind turbine.

15. The method of claim 11, further comprising:
placing the vertical-axis wind-turbines aligned in a row with the horizontal axis wind turbine such that the row of vertical-axis wind-turbines are placed downwind of the horizontal axis wind turbine, where the vertical-axis wind-turbines placed downwind of the horizontal-axis wind-turbines increase the speed of wind flowing through the upwind horizontal-axis wind-turbines' rotors by creating a greater pressure difference between the front side and the back side of the horizontal axis wind turbine.

16. The method of claim 11, further comprising:
placing the vertical-axis wind-turbines aligned in two or more rows of vertical-axis wind-turbines with the horizontal axis wind turbine such that the vertical-axis wind-turbines are placed behind the horizontal axis wind turbine from a perspective of a normal direction of the wind blowing on the horizontal axis wind turbine, where the two or more rows of vertical-axis wind-turbines set behind the horizontal axis wind turbine create a speed up effect on the turning of the blade of the horizontal axis wind turbine due to creating a greater differential pressure between the front side of the horizontal axis wind turbine and the back side of the horizontal axis wind turbine, where a first row of vertical-axis wind-turbines closer to the horizontal axis wind turbine is set as a lowest row of vertical axis wind turbine from the ground, where a second row of vertical-axis wind-turbines farthest from the horizontal axis wind turbine is set as a highest row.

17. The method of claim 11, further comprising:
placing the vertical-axis wind-turbines aligned in a row to have two or more vertical-axis wind-turbines set at different heights within that row, where a first single or set of vertical-axis wind-turbines is higher from the ground than a second single or set of vertical-axis wind-turbines in that row, where each different set of vertical-axis wind-turbines at the different heights forms its own wind wall and corresponding multiple zones of wind to affect the turbine blade and rotor of the horizontal axis wind turbine.

18. The method of claim 17, where the second set of vertical-axis wind-turbines in that row is closer to a centerline of a column supporting the horizontal axis wind turbine and the first set of vertical-axis wind-turbines is farther from the centerline of the column supporting the horizontal axis wind turbine, where the multiple zones include a turbulence zone and a speed zone, where the different heights of the wind walls formed benefit the lift on the blades of the horizontal axis wind turbine as they rotate circularly across the width of the row of vertical-axis wind-turbines, where the speed zone of wind boosts wind speed and increases the lift on and torque realized by the turbine blades in the speed zone of its corresponding wind wall as the blades go through their circular circumference motion on the horizontal axis wind turbine.

19. The method of claim 11, further comprising:
placing two or more rows of vertical-axis wind-turbines upwind of the horizontal axis wind turbine, where a first vertical axis wind turbine in a first row close couples to pair with a neighboring vertical axis wind turbine to create a coupled vortex effect of shed vortices by which higher altitude winds are brought closer to the ground and resulting wind speed that turns the rotor of the horizontal axis wind turbine is increased, where the first vertical axis wind turbine and the neighboring vertical axis wind turbine are closely coupled at less than or equal to a radius of the vertical-axis wind-turbines, where the radius of the vertical-axis wind-turbines is measured between a center of the rotor to an outside edge of the blades.

20. The method of claim 11, where a first vertical axis wind turbine is placed close to a tower of the horizontal axis wind turbine such that the blades of the vertical axis wind turbine pass at a distance from the tower equal to or less than a radius of the vertical axis wind turbine rotor, and where a resulting gap created by the placement increases the wind speed creating lift on the turbine blade of the vertical axis wind turbine.
